(19) United States
(12) Patent Application Publication
(10) Pub. No.: US 2023/0000057 A1
(43) Pub. Date: Jan. 5, 2023

(54) METHOD, SYSTEM, AND COMPUTER PROGRAM PRODUCT FOR MONITORING STATE OF ANIMAL AND PROVIDING SOLUTION

(71) Applicant: DD Cares Co., Ltd, Seongnam-si (KR)

(72) Inventor: Sang Hyun KIM, Gyeonggi-do (KR)

(21) Appl. No.: 17/837,494

(22) Filed: Jun. 10, 2022

(30) Foreign Application Priority Data
Jul. 5, 2021 (KR) 10-2021-0087867
Nov. 16, 2021 (KR) 10-2121-0157695

(51) Int. Cl. A01K 29/00; A01K 27/00; G06Q 30/06; G06Q 30/02

(52) U.S. Cl. CPC A01K 29/005; A01K 27/009; G06Q 30/0631; G06Q 30/0251

(57) ABSTRACT

This application relates to a non-transitory computer-readable storage medium. In one aspect, the computer-readable storage medium includes instructions configured to cause a processor for calculating an appropriate feed amount based on animal characteristic information to receive one or more pieces of first animal characteristic information. The one or more pieces of first animal characteristic information may include at least piece of activity level information of a first animal. The instructions may further cause the processor to calculate a maintenance energy requirement (MER) of the first animal, based on the received one or more pieces of first animal characteristic information and an MER calculation model.

### CROSS-REFERENCE TO RELATED APPLICATIONS

This application is based on and claims priority under 35 U.S.C. § 119 to Korean Patent Application No. 10-2021-0087867, filed on Jul. 5, 2021 and Korean Patent Application No. 10-2021-0157695, filed on Nov. 16, 2021, in the Korean Intellectual Property Office, the disclosure of each of which is incorporated by reference herein in its entirety.

### BACKGROUND

### Technical Field

The disclosure relates to a method, system, and computer program product for monitoring a state of an animal and providing a solution.

### Description of Related Technology

The number of people who perceive animals, especially dogs and cats, as animals and manage the animals is continuously increasing. Recently, a large number of animals suffer from obesity, arthritis, separation anxiety, skin diseases, and allergies, but due to limitations on communication with animals, it is difficult to detect health problems during initial symptoms, and thus health may deteriorate and treatment costs may increase.

### SUMMARY

Provided are a method, system, and computer program product for monitoring a state of an animal and providing a solution. Additional aspects will be set forth in part in the description which follows and, in part, will be apparent from the description, or may be learned by practice of the presented embodiments of the disclosure.

According to one aspect of the disclosure, a system for monitoring a state of an animal and providing a solution, includes: a wearable device for collecting real-time state information of the animal by being worn on a part of a body of the animal; and a user terminal for communicating with the wearable device, wherein the user terminal receives the real-time state information from the wearable device, determines a health abnormality type of the animal based on the real-time state information, and provides a solution according to the health abnormality type.

The system may provide, as the solution, at least one task helpful to health of the animal, based on the health abnormality type.

The user terminal may provide, to a user, a reward according to a performance achievement of the at least one task.

The user terminal may receive new real-time state information from the wearable device after the at least one task has been performed, and update the at least one task, based on the performance achievement of the at least one task and the new real-time state information.

The user terminal may provide, as the solution, feed information helpful to the health of the animal, based on the health abnormality type.

The user terminal may obtain basic information of the animal by receiving an input from the user, and determine the health abnormality type of the animal based on the real-time state information and the basic information.

The user terminal may provide, as the solution, the at least one task helpful to the health of the animal, based on the health abnormality type and the basic information.

The user terminal may verify the basic information by comparing the real-time state information with the basic information.

According to another aspect of the disclosure, a computer program product for monitoring a state of an animal and providing a solution, includes one or more computer-readable recording media storing a program for: receiving real-time state information of the animal from a wearable device worn on a part of a body of the animal; determining a health abnormality type of the animal based on the real-time state information; and providing a solution according to the health abnormality type.

According to another aspect of the disclosure, a method of monitoring a state of an animal and providing a solution, includes: receiving real-time state information of the animal from a wearable device worn on a part of a body of the animal; determining a health abnormality type of the animal based on the real-time state information; and providing the solution according to the health abnormality type.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a system diagram including a user terminal and a wearable device, according to an embodiment.

FIG. 2 is a diagram showing an example in which a wearable device transmits real-time state information of an animal to a user terminal, according to an embodiment.

FIG. 3 is a diagram for describing an example of determining a health abnormality type of an animal, based on real-time state information of the animal, according to an embodiment.

FIG. 4 is a diagram for describing an example of providing a task as a solution, according to an embodiment.

FIG. 5 is a diagram for describing an example of providing feed information as a solution, according to an embodiment.

FIGS. 6A and 6B are diagrams for describing an example of updating a task in consideration of a task performance achievement, according to an embodiment.

FIGS. 7A and 7B are diagrams for describing an example of providing a task in consideration of basic information of an animal, according to an embodiment.

FIG. 8 is a flowchart of a method of monitoring a state of an animal and providing a solution, according to an embodiment.

FIG. 9 is a block diagram of an external server according to an embodiment.

FIG. 10 is a block diagram of an example of a product recommendation apparatus, according to an embodiment.

FIG. 11 is a flowchart of an example of a method of recommending a product, based on a state of an animal, according to an embodiment.

FIG. 12 is a diagram for describing an example in which basic information and illness information of an animal are stored in a memory, according to an embodiment.

FIG. 13 is a diagram for describing an example in which real-time state information of an animal is output, according to an embodiment.

FIG. 14 is a diagram for describing an example in which a processor estimates a current state of an animal, according to an embodiment.

FIG. 15 is a diagram for describing an example in which a processor recommends a product, according to an embodiment.

FIG. 16 is a diagram for describing an example in which a system recommends a product, according to an embodiment.

FIG. 17 is a flowchart of an example of calculating a recommended feed amount for an animal, based on animal characteristic information, and transmitting a feed repurchase notification to a user, according to an embodiment.

FIG. 18 is a diagram showing an example of a maintenance energy requirement (MER) calculation model, according to an embodiment.

FIG. 19 is a diagram showing an example of a conversion criterion for converting animal characteristic information into activity level information, according to an embodiment.

FIG. 20 is a diagram showing an example of data for generating state information of an animal.

FIGS. 21 and 22 respectively illustrate a wearable device for managing health of an animal and a method of managing health of an animal by using the wearable device, according to an embodiment of the disclosure.

FIG. 23 is a diagram showing an example of processes for obtaining activity data of an animal and estimating a specific behavior of the animal from the activity data, according to an embodiment of the disclosure.

FIGS. 24A through 24D illustrate examples of estimating a specific behavior of an animal, based on activity data of the animal, according to an embodiment of the disclosure.

FIG. 25 illustrates an example of a frequency with respect to a specific behavior estimated for an animal, according to an embodiment of the disclosure.

FIG. 26 is a diagram for describing an example of detecting a health abnormality sign of an animal by using a deep learning inference model, according to an embodiment of the disclosure.

FIG. 27 is a diagram for describing an example of estimating a risk of obesity of an animal by using a deep learning inference model, according to an embodiment of the disclosure.

FIG. 28 is a table for describing a battery management scenario of a wearable device, according to an embodiment of the disclosure.

FIG. 29 illustrates an example of a wearable device, according to an embodiment of the disclosure.

### DETAILED DESCRIPTION

There are various methods for managing animals, and one of general animal management methods only provides a simple management function, such as simply providing an image or putting food in a container, for animals left alone after owners go out. Accordingly, there is a need for a technology that can help the owners to manage health of the animals and prevent illnesses by identifying, in real-time, health conditions of the animals, beyond the general animal management methods.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the disclosure will be described in detail with reference to the accompanying drawings such that one of ordinary skill in the art may easily implement the disclosure. However, the disclosure may be implemented in various different forms and is not limited to embodiments of the disclosure described herein. Also, in the drawings, parts irrelevant to the description are omitted in order to clearly describe the disclosure, and like reference numerals designate like elements throughout the specification.

Throughout the specification, when a part is “connected” to another part, the part may not only be “directly connected” to the other part, but may also be “electrically connected” to the other part with another element in between. In addition, when a part “includes” a certain element, the part may further include another element instead of excluding the other element, unless otherwise stated.

Hereinafter, the disclosure will be described in detail with reference to accompanying drawings.

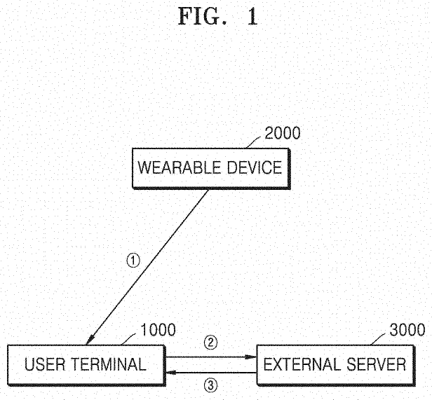

FIG. 1 is a system diagram including a user terminal 1000 and a wearable device 2000, according to an embodiment.

A system according to an embodiment may include the user terminal 1000 and the wearable device 2000. In addition, the system may further include an external server 3000.

The user terminal 1000, the wearable device 2000, and the external server 3000 may perform communication by using a network. For example, the network may include a local area network (LAN), a wide area network (WAN), a value-added network (VAN), a mobile radio communication network, a satellite communication network, or a combination thereof, is a data communication network in a comprehensive sense that enables network configuration entities shown in FIG. 1 to communicate smoothly with each other, and may include a wired Internet, a wireless Internet, and a mobile wireless communication network. Wireless communication may include, for example, wireless LAN (Wi-Fi), Bluetooth, Bluetooth low energy, Zigbee, Wi-Fi direct (WFD), ultra-wideband (UWB), infrared data association (IrDA), or near field communication (NFC), but is not limited thereto.

The user terminal 1000 may include a smartphone, a tablet personal computer (PC), a PC, a smart television (TV), a mobile phone, a personal digital assistant (PDA), a laptop computer, a media player, a micro server, a global positioning system (GPS) device, an electronic book terminal, a digital broadcasting terminal, a navigation device, a kiosk, an MP3 player, a digital camera, a home appliance, a device on which a camera is mounted, or another mobile or non-mobile computing device, but is not limited thereto.

The wearable device 2000 may be worn on a part of a body of an animal to collect real-time state information of the animal. The wearable device 2000 may include a plurality of sensors. For example, the wearable device 2000 may include at least one of an electromyography (EMG) sensor, an electrodermal activity sensor, a skin temperature measurer, a blood volume pulse measurer, an electrocardiogram (ECG) sensor, a respiration sensor, a blood pressure measurer, and a heart rate measurer. In addition, the wearable device 2000 may include a 3-axis accelerometer, a 6-axis gyroscope and accelerometer, or a 9-axis gyroscope, accelerometer, and geomagnetic sensor.

The external server 3000 may communicate with the user terminal 1000 and the wearable device 2000 through the network.

According to an embodiment, referring to a first arrow, the wearable device 2000 may transmit the real-time state information of the animal to the user terminal 1000. The wearable device 2000 may transmit the real-time state information of the animal to the user terminal 1000 through a communication method, such as wireless LAN (Wi-Fi), Bluetooth, or Bluetooth low energy. Referring to a second arrow, the user terminal 1000 may request the external server 3000 to analyze the real-time state information while transmitting the same. The external server 3000 may analyze the real-time state information to determine a health abnormality type of the animal, and may determine a solution according to the health abnormality type. Referring to a third arrow, the external server 3000 may transmit the health abnormality type of the animal and the solution to the user terminal 1000, and the user terminal 1000 may provide the health abnormality type of the animal and the solution to a user. The user terminal 1000 and the external server 3000 may exchange data through the wired Internet, the wireless Internet, or the mobile wireless communication network.

According to another embodiment, referring to the first arrow, the real-time state information of the animal obtained by the wearable device 2000 may be transmitted to the user terminal 1000. In this case, instead of transmitting the real-time state information to the external server 3000, the user terminal 1000 may self-analyze the real-time state information to determine the health abnormality type of the animal, and provide the solution according to the health abnormality type to the user.

According to another embodiment, although not shown in FIG. 1, the wearable device 2000 may directly transmit the real-time state information to the external server 3000 without going through the user terminal 1000, and request the external server 3000 to analyze the same. In this case, the external server 3000 may transmit the health abnormality type of the animal and the solution to the user terminal 1000, and the user terminal 1000 may provide the health abnormality type of the animal and the solution to the user. The user terminal 1000, the wearable device 2000, and the external server 3000 may exchange data through the wired Internet, the wireless Internet, or the mobile wireless communication network.

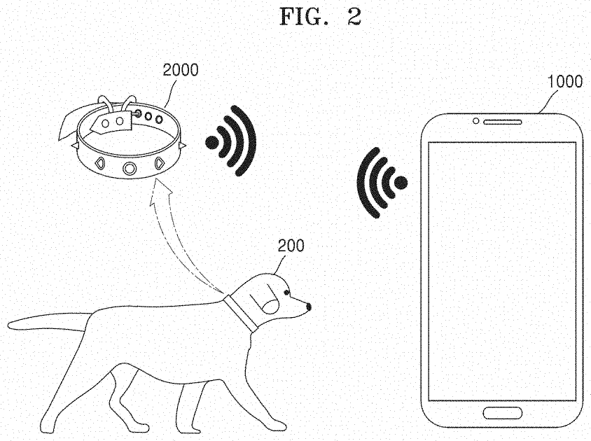

FIG. 2 is a diagram showing an example in which the wearable device 2000 transmits real-time state information of an animal 200 to the user terminal 1000, according to an embodiment.

Referring to FIG. 2, the wearable device 2000 may be worn on a part of a body of the animal 200 to collect the real-time state information of the animal 200.

According to an embodiment, the real-time state information may be information indicating whether the animal 200 is currently in an activity state or in a sleep state. In detail, the real-time state information may be information indicating whether the animal 200 is in a play state, an activity state, a rest state, or a sleep state. However, the real-time state information is not limited thereto.

The wearable device 2000 may include at least one sensor, and the wearable device 2000 may collect the real-time state information of the animal 200, based on a sensing value of the at least one sensor.

For example, the wearable device 2000 may include at least one of an EMG sensor, an electrodermal activity sensor, a skin temperature measurer, a blood volume pulse measurer, an ECG sensor, a respiration sensor, a blood pressure measurer, a heart rate measurer, a 3-axis accelerometer, a 6-axis gyroscope and accelerometer, and a 9-axis gyroscope, accelerometer, and geomagnetic sensor. The EMG sensor denotes a sensor that detects action potential of a muscle. The electrodermal activity sensor denotes a sensor that measures conductivity of a skin. The skin temperature measurer may include a sensor for detecting a temperature of a skin surface. The blood volume pulse measurer denotes a device that measures the amount of blood flowing in a blood vessel. The ECG sensor denotes a sensor that detects an electric potential related to a heartbeat on a body surface. The respiration sensor denotes a sensor that measures the number and speed of respirations. The heart rate measurer denotes a device that measures the number of times the heart beats per unit time. The 3-axis accelerometer measures acceleration, the 6-axis gyroscope and accelerometer measures acceleration and angular velocity, and the 9-axis gyroscope, accelerometer, and geomagnetic sensor measures acceleration, angular velocity, and geomagnetism.

The user terminal 1000 may receive the real-time state information of the animal 200 from the wearable device 2000.

The user terminal 1000 may determine a health abnormality type of the animal 200, based on the real-time state information. For example, the health abnormality type of the animal 200 may include arthritis, skin disease, allergy, and separation anxiety, but is not limited thereto.

Also, the user terminal 1000 may provide a solution according to the health abnormality type of the animal 200. The solution may be at least one task helpful to the health of the animal 200. Alternatively, the solution may be feed information helpful to the health of the animal 200.

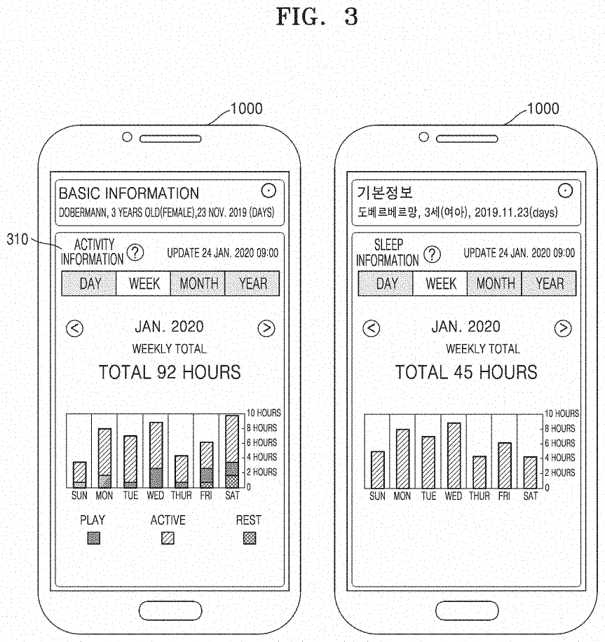

FIG. 3 is a diagram for describing an example of determining a health abnormality type of an animal, based on real-time state information of the animal, according to an embodiment.

The user terminal 1000 may receive the real-time state information of the animal from a wearable device, and determine the health abnormality type of the animal, based on the real-time state information of the animal.

Referring to FIG. 3, the user terminal 1000 may receive the real-time state information of the animal from the wearable device, accumulate the received real-time state information on daily, weekly, monthly, and yearly bases, and provide the same to a user.

According to an embodiment, the user terminal 1000 may provide the user with a total of accumulated time of each of a play state, an activity state, and a rest state among the real-time state information. Also, the user terminal 1000 may accumulate a time of a sleep state among the real-time state information, and provide the same to the user.

The user terminal 1000 may not only provide the user with the real-time state information, but also determine the health abnormality type of the animal, based on the real-time state information.

For example, when, as a result of analyzing activity information 310 among the real-time state information, a time corresponding to the play state of the animal is equal to or greater than a threshold time, the user terminal 1000 may determine the health abnormality type of the animal as separation anxiety.

Alternatively, when, as the result of analyzing the activity information 310, a time corresponding to the rest state of the animal is equal to or greater than a threshold time, the user terminal 1000 may determine the health abnormality type of the animal as arthritis.

However, the user terminal 1000 may determine the health abnormality type of the animal, taking into account various sensing values received from the wearable device, in addition to the times corresponding to the play state, activity state, rest state, and sleep state of the animal. For example, the user terminal 1000 may determine the health abnormality type of the animal, considering sensing values received from an EMG sensor, an electrodermal activity sensor, a skin temperature measurer, a blood pressure measurer, an accelerometer, and the like of the wearable device.

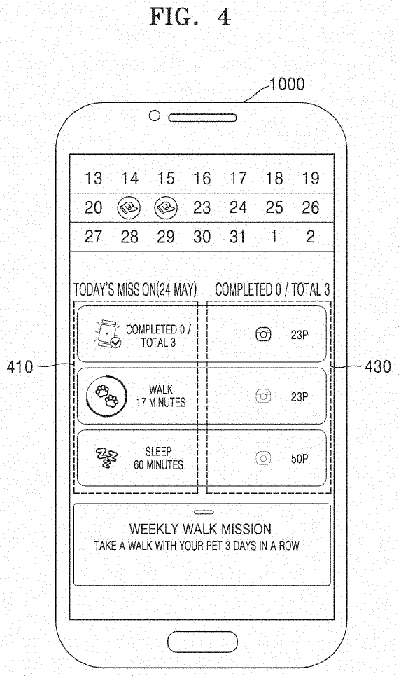

FIG. 4 is a diagram for describing an example of providing a task 410 as a solution, according to an embodiment.

The user terminal 1000 may provide, as a solution, at least one task 410 helpful to health of an animal, based on a health abnormality type of the animal. The task 410 provided by the user terminal 1000 may include the number of walks, a walking time, a sleeping time, or the like.

Referring to FIG. 4, the user terminal 1000 may provide wearing a device, a walking time, and a sleeping time as the tasks 410. In detail, when the health abnormality type of the animal is obesity, the user terminal 1000 may provide a minimum walking time as the task 410. Alternatively, when the health abnormality type of the animal is arthritis, the user terminal 1000 may provide a resting time as the task 410.

Also, the user terminal 1000 may provide a reward 430 to a user according to a performance achievement of the at least one task 410. For example, among today's tasks, 23 points may be provided as a reward if a “wear device” task is performed, 23 points may be provided as a reward if a “walk 17 minutes” task is performed, and 50 points may be provided as a reward if a “sleep 60 minutes” task is performed.

According to an embodiment, the reward 430 may be provided differentially. The reward 430 may be provided differentially depending on a task performance rate. When 50 points are provided as a reward if the “sleep 60 minutes” task is completed, 25 points may be provided as a reward if only “sleep 30 minutes” is achieved. Also, the reward 430 may be provided differentially according to a performance rate for each task 410. Depending on content of the tasks 410, certain tasks 410 may have high performance rates while other tasks 410 may have low performance rates. All tasks 410 are helpful to health of the animal, and thus, to increase a performance rate of the task 410 with a low performance rate, a higher reward 430 may be provided when the task 410 with the low performance rate is performed.

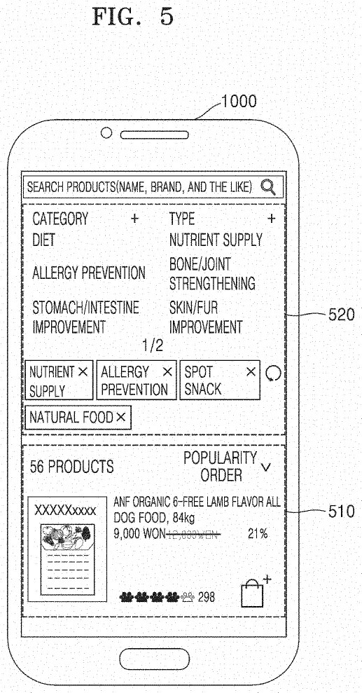

Meanwhile, the user may use the reward 430 in various ways. According to an embodiment, the user may redeem reward points in cash. According to another embodiment, the user may use the reward points to purchase a feed product provided as a solution. According to another embodiment, the user may use the reward points to take out an insurance product provided as a solution. A case in which a feed product or an insurance product is provided as a solution will be described with reference to FIG. 5.

FIG. 5 is a diagram for describing an example of providing feed information 510 as a solution, according to an embodiment.

The user terminal 1000 may provide the feed information 510 helpful to health of an animal as a solution, based on health abnormality type of the animal. The feed information 510 provided by the user terminal 1000 may include necessary nutrient information, feed product information, and the like.

In detail, when the health abnormality type of the animal is obesity, the user terminal 1000 may provide, as the feed information 510, nutrient information for a diet or a diet feed product. Alternatively, when the health abnormality type of the animal is arthritis, the user terminal 1000 may provide, as the feed information 510, nutrient information for strengthening bones/joints or a feed product for improving arthritis.

According to an embodiment, when a user purchases a feed product provided as the feed information 510, the user terminal 1000 may provide a reward.

According to an embodiment, the user may purchase the feed product provided as the feed information 510 by using the reward. Referring to FIG. 4, the user terminal 1000 may provide the reward 430 to the user according to a performance achievement of the at least one task 410. The user may purchase the feed product provided as the feed information 510 by using a reward obtained by performing a task.

Meanwhile, the user may select an additional condition 520. The user terminal 1000 may receive an input of selecting the additional condition 520 by the user. When the additional condition 520 is determined, the user terminal 1000 may provide, to the user, only feed products that satisfy the additional condition 520 from among the feed products provided as the feed information 510.

For example, when the health abnormality type of the animal is arthritis, the user terminal 1000 may provide, as the feed information 510, a feed product for improving arthritis to strengthen bones/joints. At this time, when “natural food” is determined as the additional condition 520, the user terminal 1000 may provide, to the user, only feed products that satisfy a “natural food” condition from among the feed products for improving arthritis.

Although not shown in FIG. 5, the user terminal 1000 may provide animal insurance information as a solution, based on the health abnormality type of the animal. The animal insurance information provided by the user terminal 1000 may include insurance product information. For example, when the health abnormality type of the animal is arthritis, the user terminal 1000 may provide, to the user, an insurance product including an arthritis guarantee condition. The user may use reward points to take out the insurance product provided as a solution. Also, when the user took out the insurance product provided as the solution, the user terminal 1000 may provide a reward to the user.

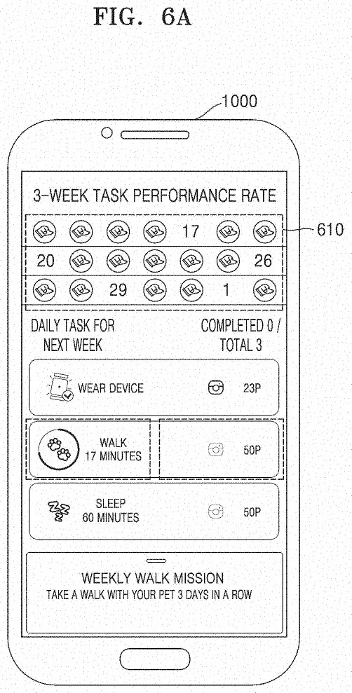

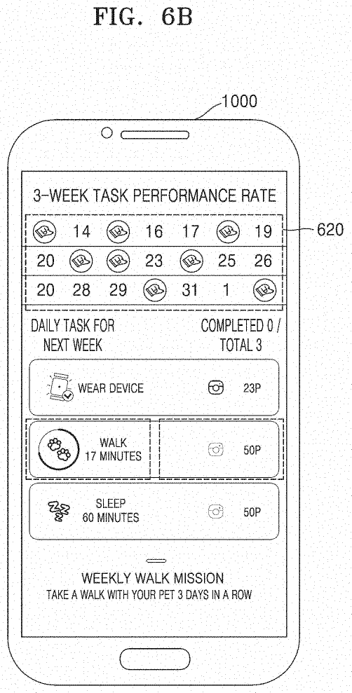

FIGS. 6A and 6B are diagrams for describing an example of updating a task in consideration of a task performance achievement, according to an embodiment.

After at least one task is performed, the user terminal 1000 may receive new real-time state information from a wearable device, and update the at least one task based on a performance achievement of the at least one task and the new real-time state information.

For example, when a health abnormality type of an animal is obesity, “walk 20 minutes” may be provided as a three-week task.

Referring to FIG. 6A, it is identified that a three-week task performance rate 610 is very high. In addition, as a result of analyzing the new real-time state information received from the wearable device after performing the task, the user terminal 1000 may derive a result that the animal moves more actively than before performing the task.

After determining that a degree of obesity of the animal has improved based on the performance achievement of the task and the new real-time state information, the user terminal 1000 may provide a “walking” task, which is decreased from existing 20 minutes to 17 minutes. Also, when a task performance rate is high, the user terminal 1000 may provide a higher reward (50 points) to the user.

On the other hand, referring to FIG. 6B, it is identified that a three-week task performance rate 620 is very low. In addition, as the result of analyzing the new real-time state information received from the wearable device after performing the task, the user terminal 1000 may derive a result that the animal moves less actively than before performing the task.

After determining that the degree of obesity of the animal has not improved based on the performance achievement of the task and the new real-time state information, the user terminal 1000 may provide a “walking” task, which is increased from existing 20 minutes to 26 minutes.

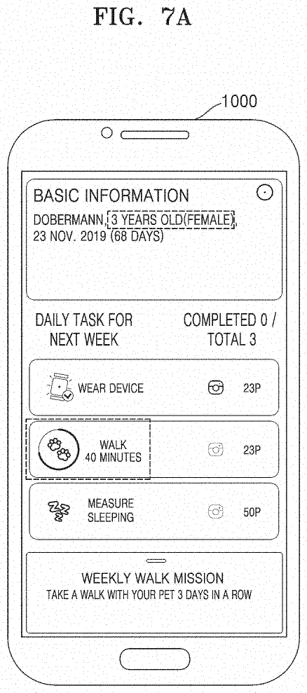

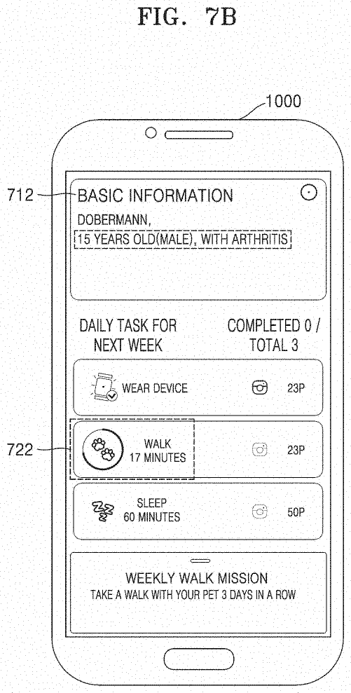

FIGS. 7A and 7B are diagrams for describing an example of providing a task in consideration of basic information of an animal, according to an embodiment.

The user terminal 1000 may receive an input from a user to obtain the basic information of the animal. The basic information of the animal may include information on a dog breed, an age, a gender, whether the animal is neutered, an illness the animal has, and whether the animal has an allergy, but the information that may be included in the basic information is not limited thereto.

As described above in FIG. 3, the user terminal 1000 may receive real-time state information of the animal from a wearable device, and determine a health abnormality type of the animal based on the real-time state information of the animal.

According to an embodiment, the user terminal 1000 may determine the health abnormality type of the animal in consideration of not only the real-time state information of the animal but also the basic information of the animal.

For example, when, as a result of analyzing activity information among the real-time state information, a time corresponding to a rest state of the animal is equal to or greater than a threshold time, the user terminal 1000 may generally determine the health abnormality type of the animal as arthritis. On the other hand, when information indicating that an age of the animal is 2 is input as the basic information of the animal, a probability of the animal suffering from arthritis at the age of 2 is slim, and thus the user terminal 1000 may determine the health abnormality type of the animal as a body ache.

In the disclosure, the health abnormality type of the animal may be more accurately determined by determining the health abnormality type in consideration of the basic information of the animal as well as the real-time state information of the animal.

As described above in FIG. 4, the user terminal 1000 may provide, as a solution, at least one task helpful to health of the animal, based on the health abnormality type of the animal. Also, as described above in FIG. 5, the user terminal 1000 may provide, as a solution, feed information and animal insurance information helpful to the health of the animal, based on the health abnormality type of the animal.

According to an embodiment, the user terminal 1000 may provide, as a solution, at least one task, in consideration of the basic information of the animal as well as the health abnormality type of the animal. Hereinafter, an embodiment will be described based on a premise that the health abnormality type of the animal is obesity.

Referring to FIG. 7A, as basic information 711 of an animal, information indicating that the animal is 3 years old may be input. Since a health abnormality type of the animal is obesity, “walk 40 minutes” may be provided as a today's task.

On the other hand, referring to FIG. 7B, as basic information 712 of an animal, information indicating that the animal is 15 years old and has arthritis may be input. Since a health abnormality type of the animal is obesity, “walk 40 minutes” is generally provided as a today's task, but considering the basic information 712 of the animal, there is a possibility that a long walk may aggravate the arthritis. The user terminal 1000 may provide, as the today's task, “walk 17 minutes” that has a reduced time than a general case, in consideration of not only the health abnormality type of the animal, but also the basic information 712 of the animal.

According to another embodiment, the user terminal 1000 may provide, as a solution, feed information, in consideration of basic information of an animal as well as health abnormality type of the animal. For example, information indicating that the animal is allergic to a specific ingredient may be input as the basic information of the animal. In this case, the user terminal 1000 may provide, to a user, only feed products that do not contain the specific ingredient from among diet feed products.

According to another embodiment, the user terminal 1000 may provide, as a solution, animal insurance information, in consideration of basic information of an animal as well as health abnormality type of the animal. For example, information indicating that the animal is 15 years old and a dog breed of the animal may be input as the basic information of the animal. In this case, the user terminal 1000 may provide, to a user, insurance products that guarantee an illness a specific dog breed type generally has when the specific dog breed ages.

In the disclosure, a more accurate solution customized for each animal may be provided by providing a solution in consideration of not only the health abnormality type of the animal, but also the basic information of the animal.

The user terminal 1000 may compare real-time state information with basic information to verify whether input basic information is correct.

According to an embodiment, the user terminal 1000 may obtain, as basic information of an animal, information indicating that the animal has an illness A. As a result of analyzing real-time state information of the animal, the user terminal 1000 may determine that a health abnormality type of the animal is more likely to correspond to an illness B than the illness A. As such, there is a possibility that the basic information of the animal, which the user knows, is wrong or that the basic information has changed over time.

The real-time state information of the disclosure is information that most accurately shows a current state of the animal, and in the disclosure, by comparing the real-time state information with the basic information, more accurate basic information about the animal may be provided to a user.

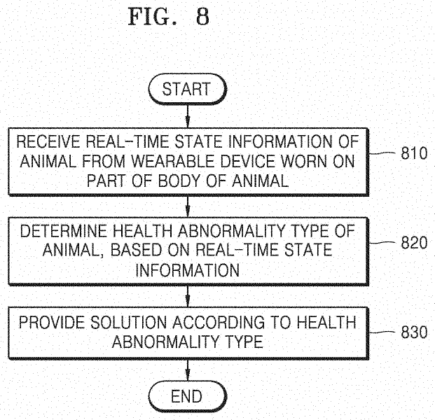

FIG. 8 is a flowchart of a method of monitoring a state of an animal and providing a solution, according to an embodiment.

Referring to FIG. 8, in operation 810, a processor may receive real-time state information of an animal from a wearable device worn on a part of a body of the animal.

The wearable device may include at least one sensor, and the wearable device may collect the real-time state information of the animal, based on a sensing value of the at least one sensor.

According to an embodiment, the real-time state information may be information indicating whether the animal is currently in an activity state or in a sleep state. In detail, the real-time state information may be information indicating whether the animal is in a play state, an activity state, a rest state, or a sleep state. However, the real-time state information is not limited thereto.

In operation 820, the processor may determine a health abnormality type of the animal based on the real-time state information.

The health abnormality type may include arthritis, skin disease, allergy, and separation anxiety, but is not limited thereto.

For example, when, as a result of analyzing activity information among the real-time state information, a time corresponding to the play state of the animal is equal to or greater than a threshold time, the processor may determine the health abnormality type of the animal as separation anxiety. Alternatively, when, as the result of analyzing the activity information, a time corresponding to the rest state of the animal is equal to or greater than a threshold time, the processor may determine the health abnormality type of the animal as arthritis.

According to an embodiment, the processor may receive an input from a user to obtain basic information of the animal, and determine the health abnormality type of the animal based on the real-time state information and the basic information.

The basic information of the animal may include information on a dog breed, an age, a gender, whether the animal is neutered, an illness the animal has, and whether the animal has an allergy, but the information that may be included in the basic information is not limited thereto.

For example, when, as the result of analyzing the activity information among the real-time state information, the time corresponding to the rest state of the animal is equal to or greater than the threshold time, the processor may generally determine the health abnormality type of the animal as arthritis. On the other hand, when information indicating that the animal is 2 years old is input as the basic information of the animal, a probability of the animal suffering from arthritis at the age of 2 is slim, and thus the processor may determine the health abnormality type of the animal as a body ache.

According to an embodiment, the processor may verify the basic information by comparing the real-time state information with the basic information. The processor may obtain, as the basic information of the animal, information indicating that the animal has the illness A. As the result of analyzing the real-time state information of the animal, the processor may determine that the health abnormality type of the animal is more likely to correspond to the illness B than the illness A.

In operation 830, the processor may provide a solution according to the health abnormality type.

According to an embodiment, the processor may provide, as the solution, at least one task helpful to health of the animal, based on the health abnormality type.

Also, the processor may provide a reward to the user according to a performance achievement of the at least one task.

After the at least one task is performed, the processor may receive new real-time state information from the wearable device, and update the at least one task based on a performance achievement of the at least one task and the new real-time state information.

According to another embodiment, the processor may provide, as the solution, feed information helpful to the health of the animal, based on the health abnormality type.

When the basic information of the animal is obtained from the user, the processor may provide, as the solution, at least one task or feed information helpful to the health of the animal, based on the health abnormality type and the basic information.

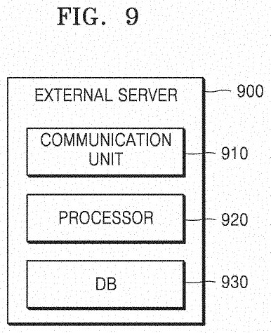

FIG. 9 is a block diagram of an external server 900 according to an embodiment.

Referring to FIG. 9, the external server 900 may include a communication unit 910, a processor 920, and a database (DB) 930. Only components related to an embodiment are shown in the external server 900 of FIG. 9. Accordingly, it may be understood by one of ordinary skill in the art that other general-purpose components may be further included in addition to the components shown in FIG. 9.

The communication unit 910 may include one or more components for performing wired/wireless communication with user terminals and payment information providing servers. For example, the communication unit 910 may include at least one of a short-range communication unit (not shown), a mobile communication unit (not shown), and a broadcast receiving unit (not shown).

The DB 930 is hardware storing various types of data processed in the external server 900, and may store a program for processing and controlling by the processor 920.

The DB 930 may include a random-access memory (RAM) such as a dynamic random-access memory (DRAM) or a static random-access memory (SRAM), a read-only memory (ROM), an electrically erasable programmable read-only memory (EEPROM), CD-ROM, Blu-ray or another optical disk storage, a hard disk drive (HDD), a solid-state drive (SSD), or a flash memory.

The processor 920 controls overall operations of the external server 900. For example, the processor 920 may generally control an input unit (not shown), a display (not shown), the communication unit 910, the DB 930, and the like by executing programs stored in the DB 930. The processor 920 may control operations of the external server 900 by executing programs stored in the DB 930.

The processor 920 may be realized by using at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and other electrical units for performing functions.

The external server 900 may communicate with a user terminal and a wearable device worn on a part of a body of an animal, through the communication unit 910.

The communication unit 910 may receive real-time state information of the animal from the user terminal or the wearable device.

The DB 930 may store the real-time state information of the animal.

The processor 920 may determine a health abnormality type of the animal, based on the real-time state information of the animal. Also, the processor 920 may determine a solution according to the health abnormality type.

The DB 930 may store the health abnormality type according to the real-time state information of the animal and the solution according to the health abnormality type, which are determined by the processor 920.

The communication unit 910 may transmit the health abnormality type and solution to the user terminal or the wearable device.

As a selective embodiment, the external server 900 of FIG. 9 may communicate with the user terminal and the wearable device worn on the part of the body of the animal, through the communication unit 910.

The communication unit 910 may receive animal characteristic information from the user terminal or the wearable device.

The animal characteristic information may be stored in the DB 930.

The processor 920 may determine a maintenance energy requirement (MER) of the animal based on the animal characteristic information. Also, the processor 920 may determine at least one of a notification regarding whether to repurchase a feed according to the MER, state information of the animal, and recommended feed information.

The DB 930 may store at least one of the MER according to the animal characteristic information, the notification regarding whether to repurchase a feed according to the MER, the state information of the animal, and the recommended feed information, which are determined by the processor 920.

The communication unit 910 may transmit, to the user terminal or the wearable device, at least one of the MER, the notification regarding whether to repurchase a feed, the state information of the animal, and the recommended feed information.

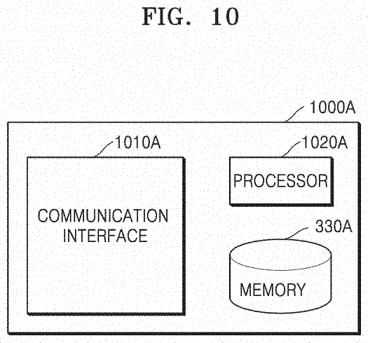

FIG. 10 is a block diagram of an example of a product recommendation apparatus 1000A, according to an embodiment.

Referring to FIG. 10, the product recommendation apparatus 1000A includes a communication interface 1010A, a processor 1020A, and a memory 330A. Only components related to an embodiment are shown in the product recommendation apparatus 1000A of FIG. 10. Accordingly, it may be understood by one of ordinary skill in the art that general-purpose components other than those shown in FIG. 10 may be further included in the product recommendation apparatus 1000A.

The product recommendation apparatus 1000A may be the user terminal 1000 or the external server 3000 described above with reference to FIG. 1. Accordingly, details described above with reference to the user terminal 1000 or the external server 3000 of FIG. 1 may be applied to the product recommendation apparatus 1000A of FIG. 10 even if omitted below.

The communication interface 1010A may include one or more components for performing wired or wireless communication with an external device. For example, the communication interface 1010A may include at least one of a short-range communication unit (not shown), a mobile communication unit (not shown), and a broadcast receiving unit (not shown).

For example, the communication interface 1010A may receive basic information and illness information of an animal from the external device. When the product recommendation apparatus 1000A is the user terminal 1000, the external device may be the external server 3000 or the wearable device 2000. Alternatively, when the product recommendation apparatus 1000A is the external server 3000, the external device may be the user terminal 1000 or the wearable device 2000.

In the above-described embodiment, it is described that the product recommendation apparatus 1000A receives the basic information and illness information of the animal from the external device, but the embodiment is not limited thereto. In other words, the basic information and illness information of the animal may be self-obtained or generated by the product recommendation apparatus 1000A.

The memory 330A is hardware storing various types of data processed in the product recommendation apparatus 1000A, and may store a program for processing and controlling by the processor 1020A.

For example, the memory 330A may store the basic information and illness information of the animal, information on a current state of the animal, and information about a recommended product.

The memory 330A may include RAM such as DRAM or SRAM, ROM, EEPROM, CD-ROM, Blu-ray or another optical disk storage, a HDD, an SSD, or a flash memory.

The processor 1020A controls overall operations of the product recommendation apparatus 1000A. For example, the processor 1020A may generally control an input unit (not shown), a display (not shown), the communication interface 1010A, the memory 330A, and the like by executing programs stored in the memory 330A. The processor 1020A may control operation of the product recommendation apparatus 1000A by executing programs stored in the memory 330A.

For example, the processor 1020A may estimate the current state of the animal, based on the basic information and illness information of the animal. In addition, the processor 1020A may recommend a product corresponding to the current state of the animal. Also, the processor 1020A may provide a reward to a user, based on whether the recommended product is purchased.

For example, the processor 1020A may be realized by using at least one of an ASIC, a DSP, a DSPD, a PLD, an FPGA, a controller, a micro-controller, a microprocessor, and other electrical units for performing functions.

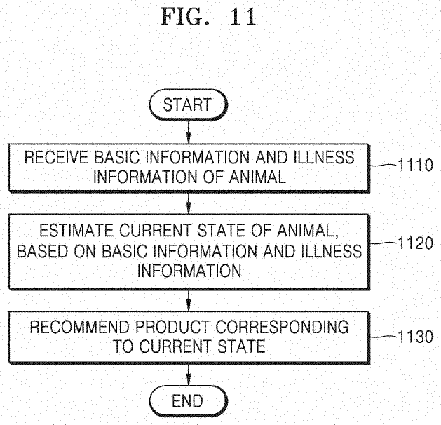

Hereinafter, a method in which the processor 1020A recommends a product based on a state of an animal will be described in detail with reference to FIGS. 11 to 16.

FIG. 11 is a flowchart of an example of a method of recommending a product, based on a state of an animal, according to an embodiment.

Referring to FIG. 11, the method of recommending a product, based on the state of the animal includes operations performed in time series by the user terminal 1000, the wearable device 2000, or the external server 3000 shown in FIG. 1. Thus, even if omitted below, details described above with respect to the user terminal 1000, the wearable device 2000, or the external server 3000 shown in FIGS. 1 and 2 may be applied to the method of FIG. 11 of recommending a product, based on the state of the animal.

In operation 1110, the communication interface 1010A receives basic information and illness information of the animal.

The basic information of the animal includes at least one of a type of the animal, a breed of the animal, an age of the animal, a gender of the animal, a real-time state of the animal, and whether the animal is neutered. For example, when the animal is a dog, the type of the animal denotes a dog, and the breed of the animal denotes a Dobermann, a poodle, a bulldog, an Alaskan malamute, or the like.

Meanwhile, real-time state information of the animal may be collected by the wearable device 2000, and received through the communication interface 1010A. In detail, the real-time state information may be information indicating whether the animal is in a play state, an activity state, a rest state, or a sleep state. However, types of the real-time state information are not limited to the above examples. An example of collecting the real-time state information of the animal by the wearable device 2000 is as described above with reference to FIG. 2.

The illness information of the animal includes at least one of an illness the animal currently suffers from, an illness the animal has suffered in the past, and an allergy of the animal. Here, a type of illness is not limited, and a cause of allergy is not limited to specific examples.

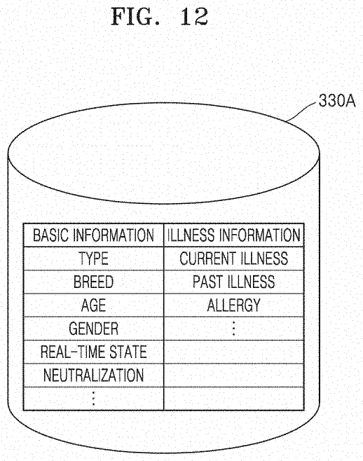

Meanwhile, the basic information and illness information of the animal may be stored in the memory 330A. Hereinafter, an example in which the basic information and illness information of the animal are stored in the memory 330A will be described with reference to FIG. 12.

FIG. 12 is a diagram for describing an example in which the basic information and illness information of the animal are stored in the memory 330A, according to an embodiment.

FIG. 12 shows an example in which the basic information and illness information of the animal are stored in the memory 330A. The basic information and illness information may be very diverse. Accordingly, the memory 330A may store various pieces of information included in the basic information and various pieces of information included in the illness information separately from each other. Also, when a user raises a plurality of animals, the basic information and the illness information may be separately stored in the memory 330A for each of the plurality of animals.

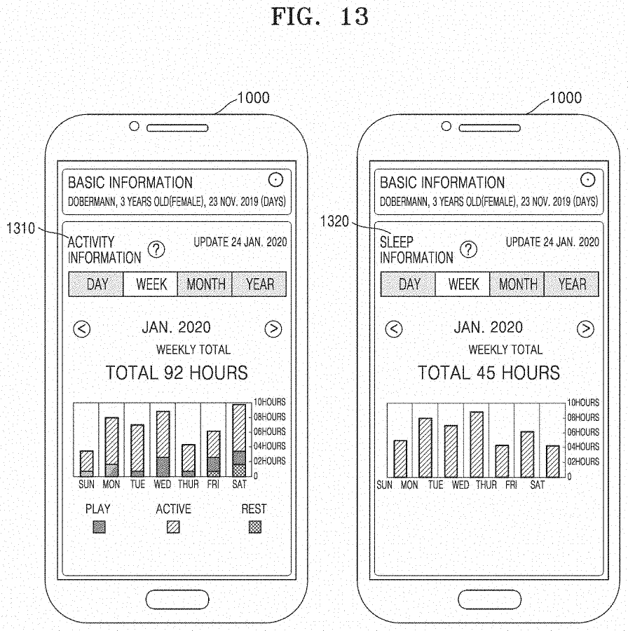

The processor 1020A may output the real-time state information of the animal through a display, and the user may identify the real-time state of the animal based on the output real-time state information. Hereinafter, an example in which the processor 1020A outputs the real-time state information of the animal will be described with reference to FIG. 13.

FIG. 13 is a diagram for describing an example in which the real-time state information of the animal is output, according to an embodiment.

The communication interface 1010A may receive the real-time state information of the animal from the wearable device 2000, and the processor 1020A may output the real-time state information of the animal through the display.

For example, referring to FIG. 10, the user terminal 1000 may receive the real-time state information of the animal from the wearable device 2000, accumulate the received real-time state information on daily, weekly, monthly, and yearly bases, and provide the same to the user.

According to an embodiment, the user terminal 1000 may provide the user with, as activity information 1310, a total of accumulated time of each of a play state, an activity state, and a rest state among the real-time state information. Also, the user terminal 1000 may accumulate a time of a sleep state among the real-time state information, and provide the same to the user as sleep information 1320.

The user terminal 1000 may not only provide the user with the real-time state information of the animal, but also determine a health abnormality type of the animal, based on the real-time state information.

For example, when, as a result of analyzing the activity information 1310 among the real-time state information, a time corresponding to the play state of the animal is equal to or greater than a threshold time, the user terminal 1000 may determine the health abnormality type of the animal as separation anxiety.

Alternatively, when, as the result of analyzing the activity information 1310, a time corresponding to the rest state of the animal is equal to or greater than a threshold time, the user terminal 1000 may determine the health abnormality type of the animal as arthritis.

However, the user terminal 1000 may determine the health abnormality type of the animal, taking into account various sensing values received from the wearable device 2000, in addition to the times corresponding to the play state, activity state, rest state, and sleep state of the animal. For example, the user terminal 1000 may determine the health abnormality type of the animal, considering sensing values received from the EMG sensor, the electrodermal activity sensor, the skin temperature measurer, the blood pressure measurer, the accelerometer, and the like of the wearable device 2000.

Referring back to FIG. 11, in operation 1120, the processor 1020A estimates a current state of the animal based on the basic information and the illness information.

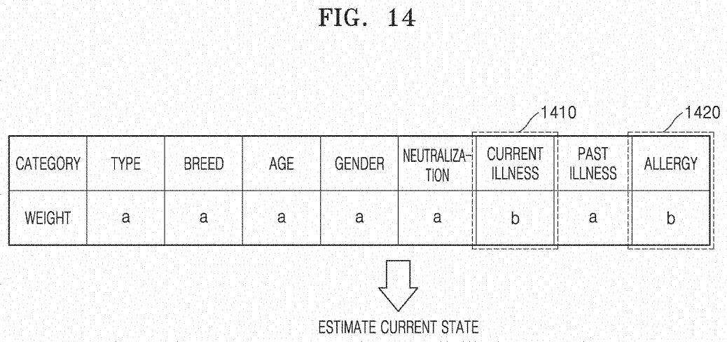

The processor 1020A may estimate the current state of the animal by considering all of the basic information and the illness information stored in the memory 330A, or by selecting some of the basic information and the illness information. For example, the processor 1020A may estimate the current state of the animal by combining a plurality of first elements (information) included in the basic information and a plurality of second elements (information) included in the illness information. Here, the processor 1020A may estimate the current state of the animal by applying a predetermined weight to each of the first and second elements. Hereinafter, an example in which the processor 1020A estimates the current state of the animal will be described with reference to FIG. 14.

FIG. 14 is a diagram for describing an example in which the processor 1020A estimates the current state of the animal, according to an embodiment.

FIG. 14 shows various types of basic information and illness information of the animal. For example, various types of basic information and illness information may include a type, a breed, an age, a gender, neutralization, a current illness, a past illness, allergy, and the like of the animal.

The processor 1020A may estimate the current state of the animal, by combining the various types of information of the animal. Here, the processor 1020A may estimate the current state of the animal by applying a predetermined weight to each of various types of information.

For example, the processor 1020A may set weights for a current illness 1410 and allergy 1420 of the animal to be different from weights for other pieces of information. In general, the current illness 1410 and allergy 1420 are identified as very important factors in estimating the current state of the animal. Accordingly, the processor 1020A may assign higher weights to the current illness 1410 and allergy 1420 than other pieces of information. In this case, while estimating the current state of the animal, the current illness 1410 and allergy 1420 may have greater influences than the other pieces of information.

Although FIG. 14 illustrates that the current illness 1410 and the allergy 1420 have the same weights, the disclosure is not limited thereto. In other words, when the current illness 1410 is more important information for estimating the current state of the animal, the processor 1020A may assign a higher weight for the current illness 1410 than that for the allergy 1420.

Referring back to FIG. 11, in operation 1130, the processor 1020A recommends a product corresponding to the current state of the animal.

Here, the product may be a feed and/or nutritional supplement consumed by the animal. As described above with reference to operation 1120, the processor 1020A estimates the current state of the animal. Accordingly, the product recommended by the processor 1020A may be a product helpful to the health of the animal. Thus, the user may not only identify the current state of his/her animal, but also identify a product capable of resolving a health issue of the animal.

Hereinafter, an example in which the processor 1020A recommends a product corresponding to the current state of the animal will be described with reference to FIG.

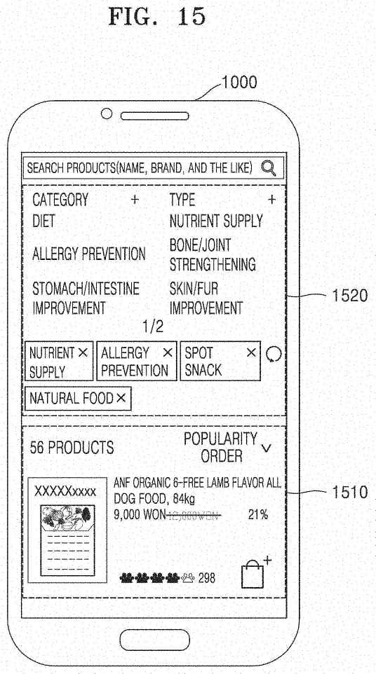

FIG. 15 is a diagram for describing an example in which the processor 1020A recommends a product, according to an embodiment.

The user terminal 1000 may provide, as a solution, information 1510 about product helpful to health of an animal, based on health abnormality type of the animal. For example, when the product is a feed for the animal, the user terminal 1000 may provide, as the information 1510, necessary nutrient information, feed product information, and the like.

In detail, when the animal is currently obese, the user terminal 1000 may provide the information 1510 about nutrient information for a diet or a diet feed product. Alternatively, when the animal is currently suffering from arthritis, the user terminal 1000 may provide the information 1510 about nutrient information for strengthening bones/joints or a feed product for improving arthritis.

For example, when a user purchases a product provided as the information 1510, the user terminal 1000 may provide a reward. At this time, the user may use the reward to purchase another product.

The user may select an additional condition 1520. The user terminal 1000 may receive an input of selecting the additional condition 1520 by the user. When the additional condition 1520 is determined, the user terminal 1000 may filter only products that satisfy the additional condition 1520 from among the products provided as the information 1510, and provide the same to the user.

Alternatively, when the animal is currently suffering from arthritis, the user terminal 1000 may provide the information 1510 about a feed product for improving arthritis to strengthen bones/joints. At this time, when “natural food” is determined as the additional condition 1520, the user terminal 1000 may filter only products that satisfy a “natural food” condition from among the feed products for improving arthritis, and provide the same to the user.

The user may use reward points to purchase a product provided as a solution. Also, when the user has purchased the product provided as the solution, the user terminal 1000 may provide a reward to the user.

Although not shown in FIG. 15, the user terminal 1000 may provide animal insurance information as a solution, based on the current state of the animal. The animal insurance information provided by the user terminal 1000 may include insurance product information. For example, when the animal is currently suffering from arthritis, the user terminal 1000 may provide, to the user, an insurance product including an arthritis guarantee condition. The user may use reward points to take out the insurance product provided as a solution. Also, when the user took out the insurance product provided as the solution, the user terminal 1000 may provide a reward to the user.

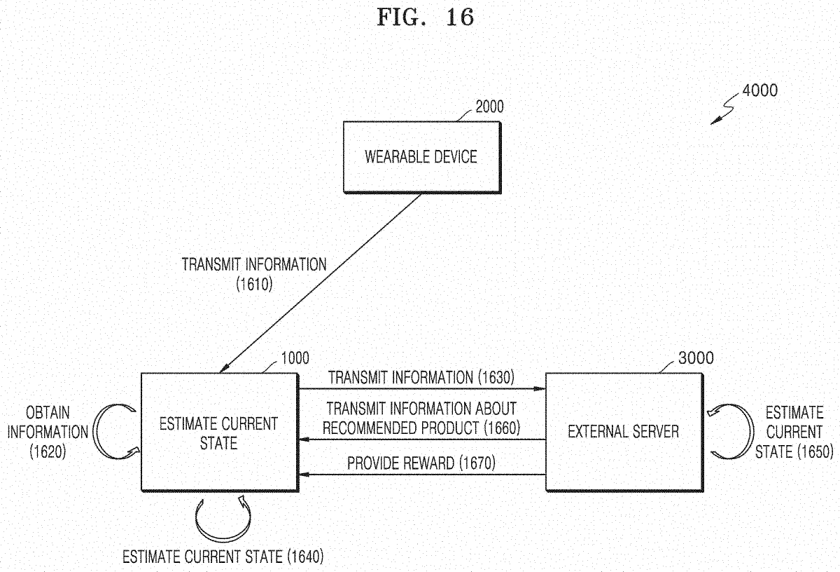

FIG. 16 is a diagram for describing an example in which a system 4000 recommends a product, according to an embodiment.

Referring to FIG. 16, the system 4000 includes the user terminal 1000, the wearable device 2000, and the external server 3000. Only components related to an embodiment are shown in the system 4000 of FIG. 16. Accordingly, it may be understood by one of ordinary skill in the art that general-purpose components other than those shown in FIG. 16 may be further included in the system 4000.

The product recommendation apparatus 1000A illustrated in FIG. 10 may correspond to the user terminal 1000 or the external server 3000 of the system 4000. Accordingly, even if omitted, details of the user terminal 1000 or the external server 3000 described above with reference to FIGS. 10 to 15 may also be applied to the system 4000 of FIG. 16.

In operation 1610, the wearable device 2000 transmits information about an animal to the user terminal 1000. For example, the wearable device 2000 may transmit the information about the animal to the user terminal 1000 through a wireless or wired communication method. Here, the information about the animal may include basic information and illness information of the animal.

The user terminal 1000 may obtain the information about the animal, in operation 1620. In other words, the user terminal 1000 may receive the information about the animal from the wearable device 2000 or self-obtain the same through a user input.

The user terminal 1000 transmits the information about the animal to the external server 3000, in operation 1630. For example, the user terminal 1000 may transmit the information about the animal to the external server 3000 through a wireless or wired communication method.

The user terminal 1000 may estimate a current state of the animal by using the information about the animal, which is transmitted from the wearable device 2000 or self-obtained, in operation 1640. Alternatively, the external server 3000 may estimate the current state of the animal by using the information about the animal transmitted from the user terminal 1000, in operation 1650. If the user terminal 1000 estimates the current state of the animal, the user terminal 1000 may transmit information about the estimated current state to the external server 3000.

The external server 3000 transmits information about a recommended product to the user terminal 1000, in operation 1660. Here, a product denotes a feed or nutritional supplement that may be consumed by the animal.

The user terminal 1000 may display the information about the recommended product transmitted from the external server 3000, and a user may determine whether to purchase the recommended product. When the user purchases the recommended product, the external server 3000 may provide a reward to the user through the user terminal 1000, in operation 1670.

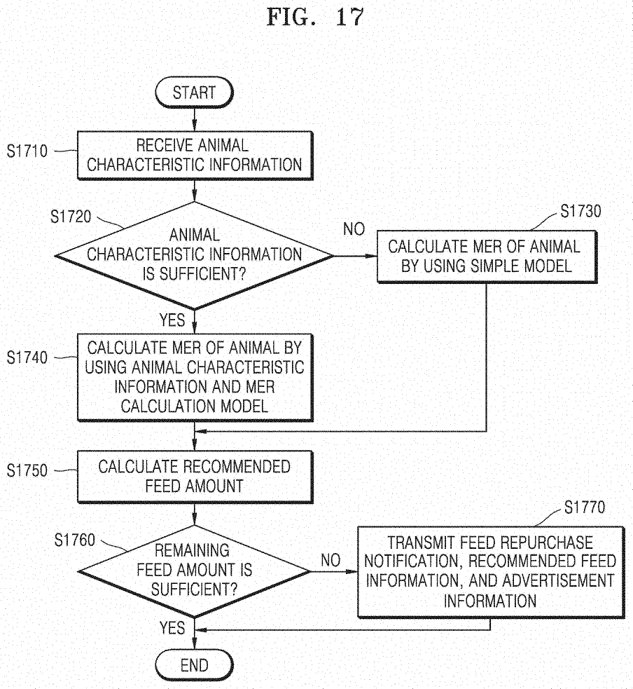

FIG. 17 is a flowchart of an example of calculating a recommended feed amount for an animal, based on animal characteristic information, and transmitting a feed repurchase notification to a user, according to an embodiment.

For convenience of description, it is assumed that individual operations shown in FIG. 17 are performed by a processor of the external server 3000. However, as described above with reference to FIGS. 1 and 2, it should be understood that each operation described below may also be performed by the user terminal 1000 or the wearable device 2000.

Referring to FIG. 17, the processor of the external server 3000 may receive animal characteristic information, in operation S1710. In the disclosure, the animal characteristic information may be information pre-stored in the external server 3000 or the user terminal 1000, information measured by the wearable device 2000, or information obtained by processing the measured information. One piece of animal characteristic information is related to one animal, and may be information representing physical and activity characteristics of the corresponding animal. The animal characteristic information may include one or more pieces of animal characteristic sub-information so as to represent various physical and active characteristics of the corresponding animal.

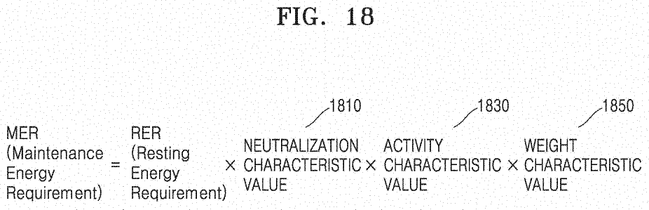

The processor of the external server 3000 may determine whether the received animal characteristic information is sufficient, in operation S1720. As will be described below with reference to FIG. 18, the animal characteristic information according to the disclosure is applied to an MER calculation model according to the disclosure to calculate an MER of the animal. The processor of the external server 3000 may calculate a recommended feed amount for the animal, based on the calculated MER, and transmit the same to a user. In this regard, the processor of the external server 3000 may examine whether the received animal characteristic information is sufficient to be applied to the MER calculation model. When the animal characteristic information is sufficient to be applied to the MER calculation model, the processor of the external server 3000 may calculate the MER of the animal by using the received animal characteristic information and the MER calculation model, in operation S1740. On the other hand, when the animal characteristic information is not sufficient to be applied to the MER calculation model, the processor of the external server 3000 may calculate the MER of the animal by using a simple model, in operation S1730. In the disclosure, a description about the simple model for calculating an MER will be omitted.

The processor of the external server 3000 may use the MER of the animal calculated in operation S1730 or S1740 to calculate the recommended feed amount of the animal, in operation S1750. In particular, the recommended feed amount of the animal may be calculated by dividing the MER of the animal by metabolizable energy (ME) of a feed. In the disclosure, the MER may denote the amount of daily energy required for the animal, and the ME may denote the amount of energy in a form that may be used purely by the animal per unit weight of feed. In other words, the processor of the external server 3000 according to the disclosure may calculate a daily recommended feed amount of the animal by dividing a daily required energy amount of the animal by energy per unit weight of a metabolizable feed. Hereinafter, an example in which the processor calculates energy per unit weight of a feed to calculate the daily recommended feed amount of the animal will be described.

According to an embodiment, the size of ME for calculating the recommended feed amount of the animal may be determined according to an ingredient composition ratio of the feed. In detail, the ME may be determined based on the amounts of crude protein, crude fat, and crude carbohydrate per unit weight of the feed. According to an embodiment, the processor may perform a process of multiplying each of the amounts of crude protein, crude fat, and crude carbohydrate by a preset coefficient so as to determine the ME. Also, in particular, commercially available feeds often do not indicate the amount of crude carbohydrate, and thus the processor may calculate the amount of crude carbohydrate by using an ingredient composition ratio of a known feed. The amount of crude carbohydrate is also referred to as nitrogen-free extract (NFE), and the content or ingredient ratio of the NFE in the feed may be calculated by subtracting the amount of crude protein, the amount of crude fat, the amount of crude fiber, the amount of moisture, and the amount of crude ash from a total feed amount or ingredient ratio. In addition, according to an embodiment, the processor may calculate the amount of crude carbohydrates, assuming that the amount of moisture is 10%. A process by which the processor calculates the amount of energy per unit weight of the feed through the above-described process may be different for each individual feed. The processor may calculate the energy per unit weight of the feed by referring to ingredient information of the individual feed stored in a DB of the external server 3000. The above-described method by which the processor calculates the energy per unit weight of the feed is merely an example, and thus the method is not limited thereto.

The processor of the external server 3000 compares the calculated recommended feed amount with a remaining feed amount stored in the DB of the external server 3000, and when the remaining feed amount is sufficient (Yes in operation S1760), the method is ended, and when the remaining feed amount is insufficient (No in operation S1760), a feed repurchase notification, recommended feed information, and advertisement information may be transmitted to the user terminal 1000 or the wearable device 2000, in operation S1770.

As described above, the processor of the external server 3000 according to the disclosure may provide the user with the feed repurchase notification, based on the calculated recommended feed amount. Content of the feed repurchase notification provided to the user may vary. According to an embodiment, the content thereof may include information indicating that the feed needs to be repurchased. According to another embodiment, the content thereof may include the recommended feed information, advertisement information on a feed, and the like. When the feed repurchase notification includes the recommended feed information, the recommended feed information may be determined in consideration of the animal characteristic information. As described above with reference to FIGS. 1 and 2, the animal characteristic information may include physical level information and activity level information of the animal, the physical level information may include information such as a species, an age, and a weight, and the activity level information may include an indicator regarding activity of the animal. Accordingly, according to an embodiment according to the disclosure, the processor of the external server 3000 may determine, as a recommended feed, a feed suitable for characteristics of the animal, in consideration of the physical level information of the animal, that is, the species and age of the animal. Alternatively, the processor of the external server 3000 may use the activity level information of the animal to determine, as the recommended feed, a feed suitable for an activity level of the animal. For example, when the activity level of the animal is high, the processor may determine, as the recommended feed, a feed having high ME, and provide information related to the determined recommended feed to the user together with the advertisement information. The processor according to the disclosure provides the recommended feed information to the user, based on the animal characteristic information including the animal activity level information measured by the wearable device 2000, and thus the processor is able to determine the recommended feed more suitable for the animal considering changes in the physical and activity levels of the animal, compared to a general recommended feed determined by only using general physical information of the animal (only considering a species or age of the animal). Also, when the advertisement information is transmitted to the user through the user terminal 1000 or the wearable device 2000, based on the recommended feed, it is possible to guide the user to rationally purchase the feed, thereby increasing loyalty of users towards a platform using the method and apparatus according to the disclosure.

FIG. 18 is a diagram showing an example of an MER calculation model, according to an embodiment.

As described above with reference to FIG. 17, an MER may denote a daily required energy amount of an animal. The external server 3000, the user terminal 1000, or the wearable device 2000 according to the disclosure may calculate the MER of the animal, based on the MER calculation model and animal characteristic information. For convenience of description, the disclosure is described based on the external server 3000, but a following description related to FIG. 18 may also be applied to the user terminal 1000 or the wearable device 2000. The MER calculation model will be described in detail below.

Referring to FIG. 18, an embodiment of the MER calculation model according to the disclosure may be calculated by using a resting energy requirement (RER), a neutralization characteristic value 1810, an activity characteristic value 1830, and a weight characteristic value 1850. According to an embodiment of the disclosure, physical level information or activity level information of an animal related to a characteristic value may be an indicator processed for MER calculation. For example, the processor of the external server 3000 may set a neutralization characteristic value to 0.8 for a neutered dog or cat, and 1.0 for an unneutered dog or cat. A characteristic value according to the disclosure may be calculated by converting physical level information or animal activity level information of a corresponding animal. For example, the physical level information or activity level information of the animal may be represented by a value indicating a related characteristic. As another example, physical level information or activity level information may also be represented by a label indicating a level of a related characteristic. Accordingly, the processor of the external server 3000 according to an embodiment of the disclosure may directly convert the physical level information or the activity level information into a neutralization characteristic value, an activity characteristic value, and a weight characteristic value by using a conversion model. The processor of the external server 3000 according to another embodiment may convert the physical level information or activity level information represented in a form of a label by using data such as a preset conversion table.

In the disclosure, the RER may denote basic energy for maintaining metabolic processes in a body when the animal does nothing in a rest state. This will be described in detail below.

In the disclosure, the neutralization characteristic value 1810 may be a value obtained by converting information about whether an animal is neutered, from among animal characteristic information, to be applied to the MER calculation model. Even when the animal is neutered, an effect of neutralization on MER calculation may vary depending on physical details, such as a species, an age, and the like, and thus the neutralization characteristic value 1810 may be determined differently according to the animal characteristic information. In detail, the processor may determine the neutralization characteristic value 1810 differently by reflecting species information and age information of the animal.

In the disclosure, the activity characteristic value 1830 may be a value obtained by converting information on the activity level information, from among the animal characteristic information, to be applied to the MER calculation model. Like the neutralization characteristic value 1810, activities of animals having a same level of activity may have different effects on the MERs, and thus the activity characteristic value 1830 may be determined differently according to the animal characteristic information. In detail, the processor may determine the activity characteristic value 1830 by reflecting the species information and age information of the animal. For example, regarding a 4-month-old dog A and a 96-month-old dog B, of which activity level information is active, the processor may determine an activity characteristic value to be 2.0 for the dog A and to be 1.5 for the dog B.

In the disclosure, the weight characteristic value 1850 may be a value obtained by converting weight information from among animal characteristic information, to be applied to the MER calculation model. Like the neutralization characteristic value 1810 and the activity characteristic value 1830, activities of animals having a same weight may have different effects on the MERs, and thus the weight characteristic value 1850 may be determined differently according to the animal characteristic information. In detail, the processor may determine the weight characteristic value 1850 by reflecting the species information and age information of the animal. For example, regarding a 4-month-old dog A and a 96-month-old dog B, of which weight levels are “overweight”, the processor may determine a weight characteristic value to be 1.8 for the dog A and to be 1.2 for the dog B.

Compared with general models presented by the NRC and National Institute of Animal Science, the MER calculation model according to the disclosure differs in that activity of an animal is reflected to MER calculation. It is clear that there are differences between individual beings even between animals of a same species and same physical characteristics. In particular, although activity is a very important factor in determining energy consumption of an individual being, conventional models do not directly reflect the activity. In other words, the conventional model determines activity indirectly and uniformly, considering an age, neutralization, pregnancy, and the like of an animal, and thus activity of an individual being is not reflected in MER calculation. Accordingly, even if an owner determines a feed amount according to the model, a feed amount suitable for an individual being may be unable to be determined. On the other hand, the MER calculation model according to the disclosure considers an activity characteristic value of an individual being. Therefore, the MER calculation model according to the disclosure may determine recommended feed amounts suitable for the individual beings by sufficiently reflecting a difference between the individual beings. Furthermore, in the disclosure, characteristic values used for MER calculation are measured by the wearable device 2000, and such measurements are performed in real time/periodically. Accordingly, the MER and recommended feed amount may be updated according to physical changes of the individual being by suitably detecting changes in characteristic information of the individual being. In other words, the MER may be suitably adjusted by considering an increase in the amount of activity, a change in activity according to an environment change, a weight change, and the like in real time while the animal grows into an adult, and accordingly, information about an appropriate level of the recommended feed amount may be transmitted to the user. Accordingly, more appropriate animal feeding management may be achieved.

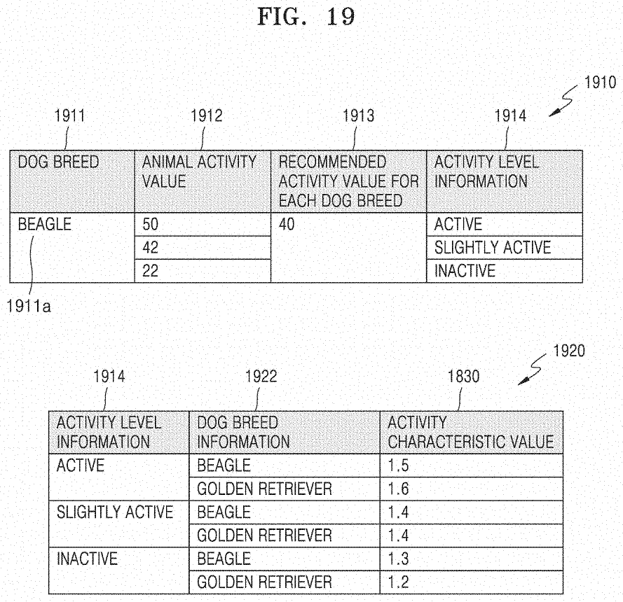

FIG. 19 is a diagram showing an example of a conversion criterion for converting animal characteristic information into activity level information, according to an embodiment.

Referring to FIG. 19, the processor of the external server 3000 according to the disclosure may determine an activity level of an animal, based on an activity level determination model 1910. The processor may determine activity level information 1914 of the animal by applying, to the activity level determination model 1910, dog breed information 1911 of the animal, an animal activity value 1912, and a recommended activity value 1913 for each dog breed. In the disclosure, the dog breed information 1911 may be one of pieces of animal characteristic sub-information included in the animal characteristic information. For example, the processor of the external server 3000 may manage the dog breed information 1911 by including the dog breed information 1911 in animal physical level information among the animal characteristic information. As described above with reference to FIGS. 1 and 2, the animal activity value 1912 may be a measurement activity value measured by the wearable device 2000 or a processed activity value obtained by processing the measured information. A detailed description about the measurement activity value or processed activity value has been described above with reference to FIG. 2, and thus details thereof are not provided again. The recommended activity value 1913 for each dog breed is a level of daily activity amount recommended for each dog breed information 1911, and may be used to determine the activity level information 1914 through comparison with the individual animal activity value 1912. According to an embodiment, the recommended activity value 1913 for each dog breed may be stored in the DB of the external server 3000, and updated through communication with a related organization (National Institute of Animal Science or the like) related to corresponding information. According to another embodiment, the recommended activity value 1913 for each dog breed may be determined by using a plurality of pieces of animal activity value information received from a plurality of wearable devices. For example, the external server 3000 may obtain the animal activity value 612 for a beagle 611a from a plurality of wearable devices or user terminals, and perform statistical processing on the obtained animal activity value 612 to use the same to determine the recommended activity value 613 for the beagle 611a. In detail, animal activity values 612 of beagles 611a in a normal weight range may be obtained from the plurality of wearable devices or user terminals, and an average value thereof may be determined as the recommended activity value 613 for the beagles 611a.

Although it has been described above that the activity level information 1914 is determined by the external server 3000, since the same processing may be performed by the wearable device 2000 or the user terminal 1000, a device that performs the processing related to the determining of the activity level information 1914 is not limited to the external server 3000.

The processor of the external server 3000 according to the disclosure may convert the animal characteristic information into a first characteristic value according to a preset conversion criterion 1920. In detail, the converted animal characteristic information may be the activity level information 1914, and the first characteristic value resulting from the conversion may be the activity characteristic value 1830 used in an MER calculation model. The processor of the external server 3000 according to the disclosure may use additional animal characteristic sub-information to determine the activity characteristic value 1830 according to the activity level information 1914. The animal characteristic sub-information may be animal species information (for example, dog breed information 1922) or animal age information. The conversion criterion 1920 may be pre-stored in the DB of the external server 3000. The conversion criterion 1920 may be stored and updated through communication with an external related organization, such as the National Institute of Animal Science. Alternatively, the processor of the external server 3000 may establish the conversion criterion 1920 for determining the activity characteristic value 1830, based on a plurality of pieces of animal characteristic information including the same animal characteristic sub-information. For example, the processor may establish a conversion criterion such that an activity characteristic value according to activity level information of beagles is determined differently from that of golden retrievers. As shown in FIG. 19, the conversion criterion 1920 may determine the activity characteristic value 1830 to be 1.5 for beagles and to be 1.6 for golden retrievers, with respect to individual beings having active as the activity level information 1914. The processor of the external server 3000 may establish such a conversion criterion 1920 by collecting a plurality of pieces of animal characteristic information having the same animal characteristic sub-information (for example, the dog breed information 1922), and continuously update the same. In other words, for example, when an activity characteristic value of 1.5 has been assigned to beagles of which activity level information is “Active” on May 16, 2021, the processor may adjust the activity characteristic value according to a result of analyzing weight changes of the beagles during a certain period of time thereafter. For example, when an average weight of the beagles of which the activity characteristic value 1830 is 1.5 is increased, the processor may update a model by adjusting the activity characteristic value 1830 to 1.45. It has been described above that the external server 3000 establishes and updates the conversion criterion 1920, and determines the activity characteristic value 1830 according to the conversion criterion 1920, but such processing may be performed not only by the external server 3000, but also by the user terminal 1000 and the wearable device 2000. Also, it will be apparent that a type of animal characteristic sub-information used in the conversion criterion 1920 is not limited to the dog breed information 1922. When a conversion criterion for determining an activity characteristic value is established and updated by analyzing a plurality of pieces of data including the same or similar pieces of animal characteristic sub-information, animal characteristic information of other animals having a physical level characteristic similar to an individual being may be reflected during MER calculation, and thus the MER calculation may be more accurately performed.

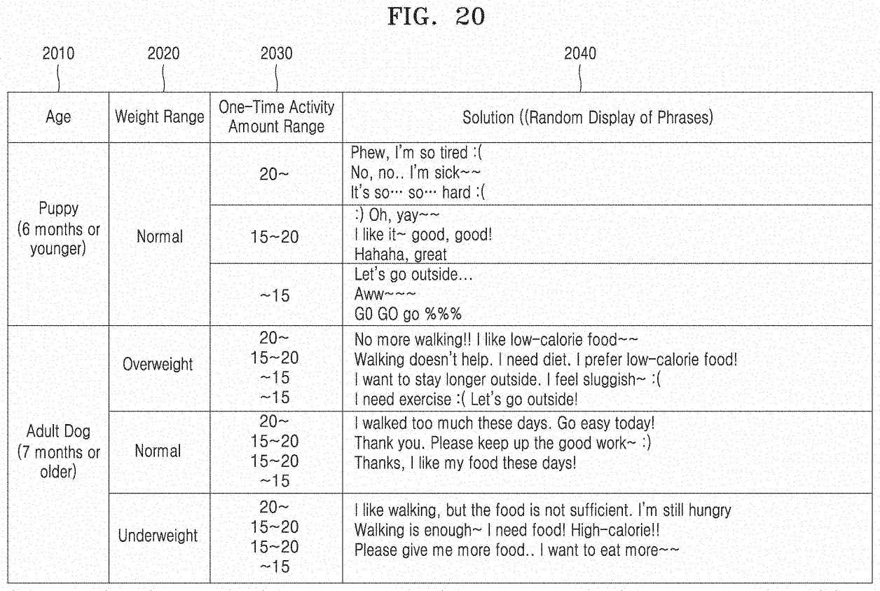

FIG. 20 is a diagram showing an example of data for generating state information 2040 of an animal.

Referring to FIG. 20, the processor of the external server 3000 according to the disclosure may generate the state information 2040 of the animal, based on animal characteristic information. Here, the state information 2040 may be information indicating appropriateness of the animal characteristic information at the time of generating the state information 2040. Alternatively, the state information 2040 may be information obtained by selecting one of a plurality of pieces of candidate state information that are related expressions, and converting the same into the appropriateness of the animal characteristic information at the time of generation. This will be described with reference to FIG. 20.

Referring to FIG. 20, the processor of the external server 3000 may generate the state information 2040 that is a responding phrase, considering an age 2010 of the animal, a weight range 2020 of the animal, and a one-time activity amount range 2030 of the animal. In detail, with reference to an adult dog, when the activity amount range 2030 of an overweight adult dog is 20˜, based on animal characteristic information, the processor may generate a phrase “No more walking!! I like low-calorie food˜˜” that is corresponding state information 2040 and transmit the same to the user terminal 1000 or wearable device 2000. As such, a current state of the animal is notified to a user such that feeding and activity amount of the animal may be suitably adjusted. When generating the state information 2040 according to the disclosure, the processor may arbitrarily generate a phrase. In detail, the processor may arbitrarily select one of a plurality of pieces of candidate state information. A method by which the processor generates the state information 2040 is not limited thereto. It has been described above that the processor of the external server 3000 generates and transmits the state information 2040, but these processes may also be performed by the user terminal 1000 and the wearable device 2000.

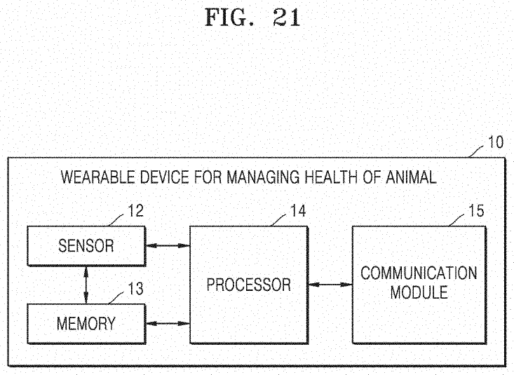

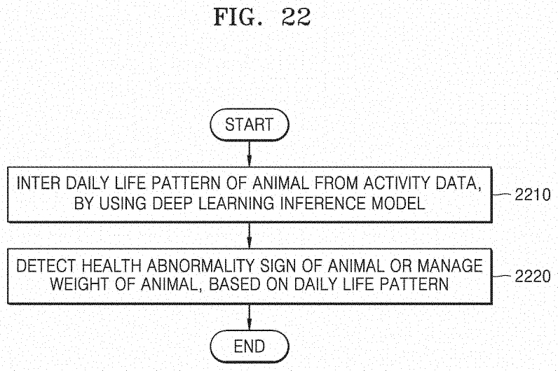

FIGS. 21 and 22 respectively illustrate a wearable device 10 for managing health of an animal and a method of managing health of an animal by using the wearable device 10, according to an embodiment of the disclosure.

Here, the wearable device 10 may be in a form of a wearable device capable of being attached to the animal's collar, necklace, clothes, bag, or the like. In this case, the wearable device 10 may be manufactured in a size that does not interfere with the activity of the animal, and may be attached to the body or clothes of the animal.

Referring to FIG. 21, the wearable device 10 may include a sensor 12, a memory 13, a processor 14, and a communication module 15.

The sensor 12 may obtain activity data of the animal in units of predetermined times. The sensor 12 may include an accelerometer, a gyroscope, or a global positioning system (GPS) sensor.

For example, the accelerometer is a sensor that detects a change in speed, and may detect size information measured from three vectors having x, y, and z axes. For example, when the sensor 12 includes the accelerometer, the sensor 12 may collect raw-data corresponding to acceleration information 10 to 100 times per second. In detail, the sensor 12 may collect the raw-data 30 to 70 times per second. In more detail, the sensor 12 may collect the raw-data 50 times per second. Compared to prior art, the sensor 12 obtains the raw-data more frequently per unit of predetermined time (for example, 1 second). Accordingly, the wearable device 10 or a server may infer a daily life pattern of the animal more accurately than in the prior art.

As another example, the gyroscope is a sensor that detects angular velocity, and may collect rotation angle information of the animal. For example, when the sensor 12 includes the gyroscope, the sensor 12 may measure data regarding a moving direction of the animal from the angular velocity in units of seconds.

The sensor 12 may collect the activity data of the animal per unit of predetermined time. For example, the sensor 12 may include the accelerometer or the gyroscope, a combination thereof, or another type of sensor.

The GPS sensor may receive, from a satellite, location information indicating a current location of the wearable device 10. When the animal equipped with the wearable device 10 performs an external activity such as a walk, the location of the animal may be tracked through a GPS signal, and the wearable device 10 may provide the location information of the animal to the user. The location of the animal may be collected through another positioning method by using a communication module, in indoors where a GPS reception signal is weak.

The memory 13 may store the obtained activity data. The activity data of the animal collected by the sensor 12 may be accumulated and stored in the memory 13. In addition, the memory 13 may record, through the processor 14, the activity data, and a specific behavior or daily life pattern of the animal estimated through a deep learning inference model. Also, the memory 13 may record an activity log of the animal, which is obtained by processing information collected with respect to the daily life pattern or specific behavior of the animal through the processor 14.

The processor 14 may detect a health abnormality sign of the animal or manage a weight of the animal, based on the stored activity data by using the deep learning inference model.

Here, there may be several types of deep learning inference models. Examples of the deep learning inference model may include a recurrent neural network (RNN) model, a convolutional long short-term memory (C-LSTM) model, and a gated recurrent unit (GRU) model, which are models that handle sequential data with respect to time.

In order for the deep learning inference model of the disclosure to detect the daily life pattern and health abnormality sign of the animal or manage the weight of the animal, based on the activity data of the animal, a deep learning model having a structure of RNN, in which a previous time step is input as a state in a following layer, may be selected. Although the deep learning model having the structure of RNN model has several advantages, there may be some issues when long-term log records are input to the corresponding deep learning inference model. In this regard, in the disclosure, the health abnormality sign of the animal may be detected by mainly using an inference model, such as the C-LSTM model, the GRU model, or a combination thereof.

For example, an optimal inference model is selected from among deep learning inference models to stabilize a performance of the wearable device 10 and obtain better inference results. The C-LSTM model or GRU model shows better efficiency in terms of gradient loss, congestion, and long-term dependency, than the RNN model.

According to an embodiment of the disclosure, the wearable device 10 may select the C-LSTM and/or the GRU model as the deep learning inference model. The C-LSTM model may perform inference dependent on a predetermined time by adding a cell state of a previous layer as a hidden state vector in a time step of each layer. The wearable device 10 may delete some of memories up to a previous cell by adding a forget gate in some layers in the C-LSTM model. Accordingly, the wearable device 10 may prevent congestion of a function according to an increase in the amount of data to be processed when using the C-LSTM model, and collect meaningful information.

The GRU model is a model having a structure more standardized than the C-LSTM model, and capable of quick calculation. Unlike the C-LSTM model that uses a cell state vector and a hidden state vector, the GRU model may only use a hidden state vector.

According to an embodiment, the processor 14 may infer the daily life pattern of the animal from the activity data, by using the deep learning inference model, in operation 2210. The deep learning inference model used in the disclosure may be referred to as “NeuroSense algorithm” below.

For example, the processor 14 may learn, as training data, an activity data accumulation record for a predetermined long period of time, which is collected from the sensor 12. Here, the activity data may be in a form of a graph in which magnitude of a speed change over time is recorded, and the processor 14 may store the activity data in units of time or units of days, and process the activity data into raw-data to infer the daily life pattern.

The processor 14 may output, as first activity content of the animal, an intermediate output obtained by analyzing the number of repetitions of the specific behavior of the animal and an aspect of the specific behavior, through the NeuroSense algorithm. For example, the processor 14 may infer the daily life pattern of the animal, which is repeated for a predetermined time, based on the first activity content through the NeuroSense algorithm, and output the same as the intermediate output.

The processor 14 may detect the health abnormality sign of the animal, based on the daily life pattern, in operation 2220.

For example, the processor 14 may determine a predetermined behavior corresponding to the activity data of the animal, based on the activity data, by using the NeuroSense algorithm. Also, the processor 14 may identify a specific behavior related to a health abnormality from among determined predetermined behaviors. In addition, the processor 14 may detect the health abnormality sign of the animal by comparing the first activity content of the animal, which is obtained by analyzing the number of repetitions of the specific behavior of the animal and the aspect of the specific behavior, estimated from the activity data, the daily life pattern of the animal, and second activity content corresponding to a normal activity range of a same breed as the animal.

For example, when the animal performs specific scratching more than a threshold value than the usual by referring to the daily life pattern of the animal, the processor 14 may detect such a behavior as the health abnormality sign (for example, a suspicious sign of a skin disease).

As another example, when the animal toss and turns a lot in bed or wakes up often without a deep sleep, with respect to a sleep behavior, the processor 14 may detect such a sleep behavior as the health abnormality sign of the animal. In this case, the wearable device 10 may notify the user that an “abnormality sign” has been found even if it is unable to accurately infer reasons for a change in a behavior pattern of the animal. When such an “abnormality sign” is continuously detected for a certain period of time, the wearable device 10 may transmit a countermeasure or recommendation for the “abnormality sign” to the user together.

Scratching or licking by the animal may not be unusual even compared with the daily life pattern of the animal or daily life patterns of other animals. The NeuroSense algorithm may further consider the second activity content corresponding to the normal activity range of the same breed in order to make an inference result more suitable for the animal.

For example, the NeuroSense algorithm may use a database about activity contents corresponding to normal activity ranges for each breed and age of the animal. It may be noted that more pieces of activity data may be collected when the animal is younger, and less pieces of activity data may be collected when the animal is older. For example, the NeuroSense algorithm may apply the age or the like of the animal as an additive or subtractive factor while setting a threshold value for classifying the excess or deficiency of a specific behavior of the animal.

According to another embodiment, the processor 14 may manage a weight of the animal, based on the daily life pattern, in operation 2220. The processor 14 may receive, as animal information, information about the activity data, type, age, and weight, to manage the weight of the animal. Here, the wearable device 10 may estimate a risk of obesity of the animal even if there is no some of the animal information described above. For example, even if the weight of the animal is not input by the user, the wearable device 10 may estimate the risk of obesity of the animal, based on the age and breed of the animal.

Here, the processor 14 may use the GRU model as an inference model for the NeuroSense algorithm. For example, the processor 14 may learn in advance a second normal activity range corresponding to a normal weight group of the same breed as the animal or a third normal activity range corresponding to an overweight group of the same breed, and estimate the risk of obesity of the animal or determine appropriateness of a weight of a specific animal by using the same.

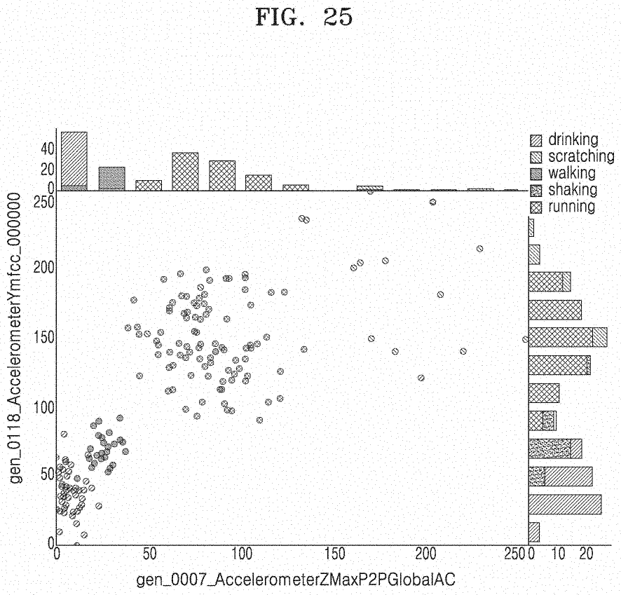

For example, the processor 14 may calculate differences between the activity data accumulation record of the animal and normal activity amounts of the normal weight/overweight groups of the same breed, and reflect, as factors, the differences to a GRU cell to estimate the risk of obesity of the animal. A detailed description thereof will be described below with reference to FIG. 25.

The processor 14 may upload, to a server, the intermediate output or output data using the NeuroSense algorithm, thereby sharing corresponding details with the user. Here, the server may be a server that drives an application interworking with the wearable device 10, and the application may provide the user with a result of analyzing activity content or activity amount of the animal, or daily life pattern information of the animal. At this time, the application may process data output through the deep learning inference model in a form of an activity log of the animal, and provide the same to the user.

For example, the user may obtain, through the application from the wearable device 10, information about the animal's activity data, activity log, daily life pattern, proper weight, risk of obesity estimation value, and health abnormality sign. When the health abnormality sign of the animal is detected, the wearable device 10 may further provide a warning notification to the user through the application.

The communication module 15 may support at least one communication method from among Wi-Fi, Bluetooth, and mobile communication, and the processor 14 may adaptively select a communication method supported through the communication module 15, according to circumstances. Here, the mobile communication may include an eMTC communication method supporting LTE.

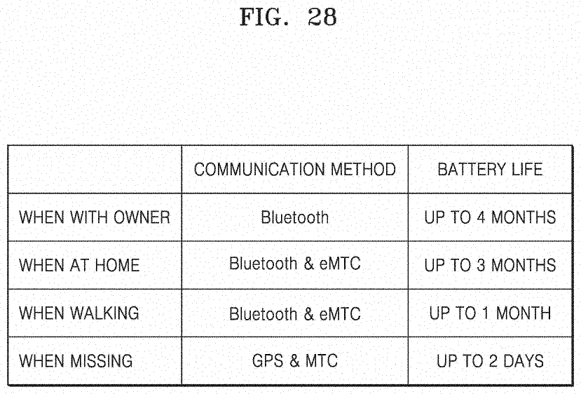

For example, the processor 14 may estimate a current location of the wearable device 10, based on a received GPS signal, and determine to switch the communication method according to a battery management scenario depending on the current location of the wearable device 10 and circumstances. A detailed description about the battery management scenario will be described below with reference to FIG. 28.

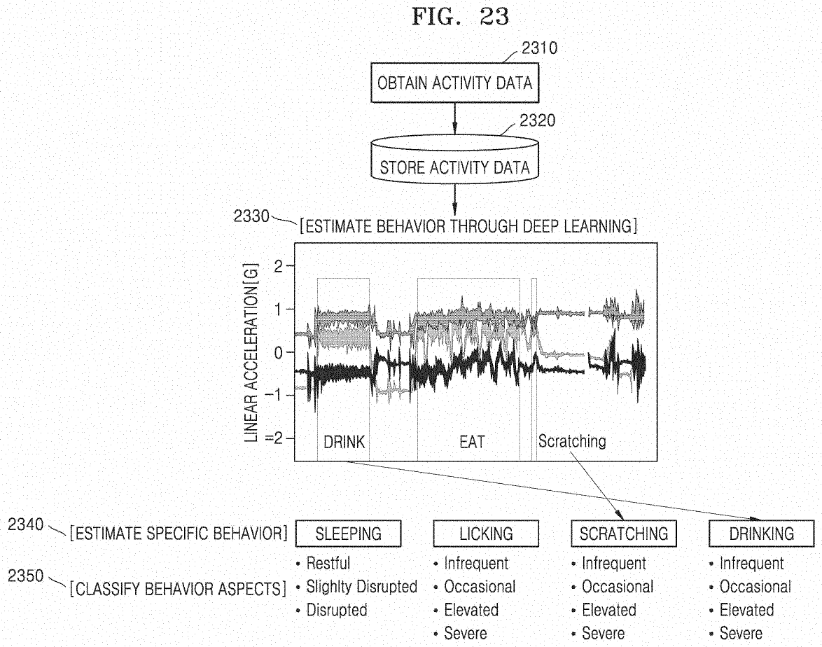

FIG. 23 is a diagram showing an example of processes for obtaining activity data of an animal and estimating a specific behavior of the animal from the activity data, according to an embodiment of the disclosure.

First, the wearable device 10 may obtain activity data, in operation 2310. The activity data contains size values obtained from various types of sensors, and by plotting the activity data, various types of activity data may be compared on a same plane. For example, x-axis, y-axis, and z-axis activity data of the animal may be obtained from a sensor attached to the wearable device 10.

Then, the wearable device 10 may store the obtained activity data in a memory, in operation 2320.

Next, the wearable device 10 may perform behavior estimation of the animal by using the NeuroSense algorithm, in operation 2330. Here, the behavior estimation may include estimating behaviors of the animal corresponding to the obtained activity data, and further may further include estimating the specific behavior that may be an indicator of a health abnormality from among the behaviors of the animal, in operation 2340. For example, the wearable device 10 may classify specific behaviors as several indicators for estimating health abnormalities of the animal, from among numerous behaviors of the animal, in operation 2350.

For example, when the wearable device 10 selects, as the indicators indicating health abnormalities, the specific behaviors, such as sleeping, licking, scratching, and drinking, the wearable device 10 may estimate the specific behavior, and analyze the number of occurrences and aspects of the specific behavior.

For example, the processor 14 may classify the sleeping of the animal as restful, slightly disturbed, disrupted, or the like, by using a classifier model.

As another example, the processor 14 may count the number of lickings or the number of scratchings of the animal. For example, the processor 14 may classify the licking or scratching of the animal as infrequent, occasional, elevated, severe, or the like, depending on the number of lickings or scratchings, by using the classifier model.

As another example, the processor 14 compares the drinking of the animal with a predetermined average value, and classify the drinking as below average, average, above average, or the like, by using the classifier model.

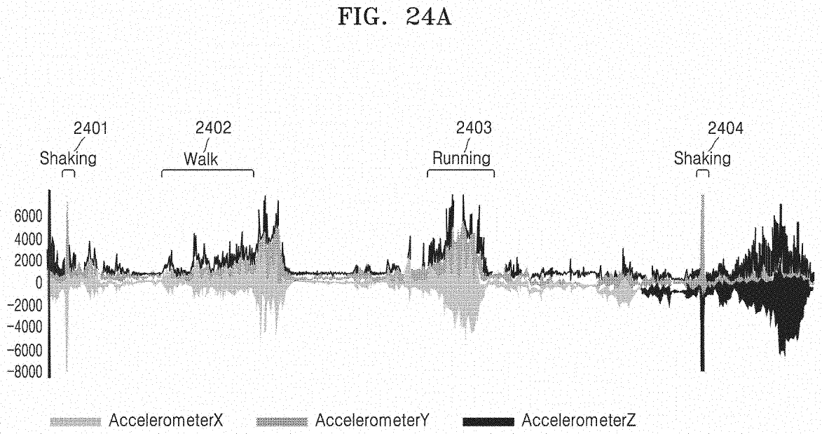

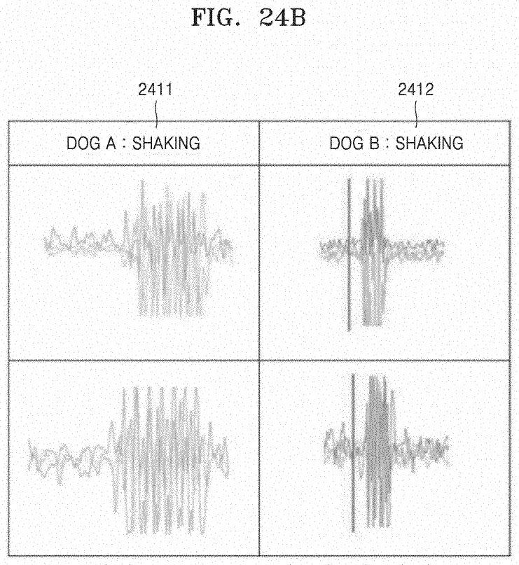

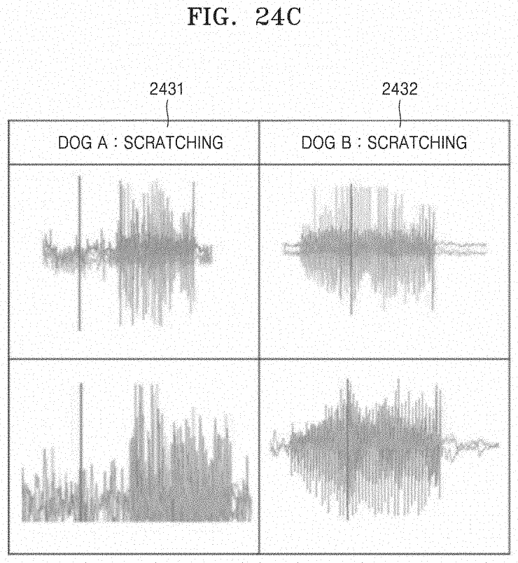

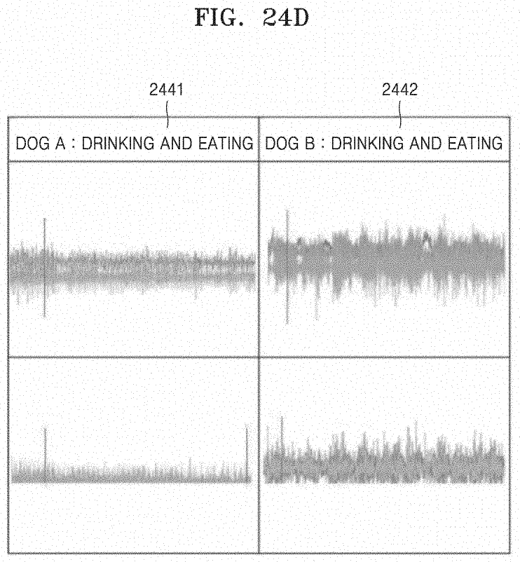

FIGS. 24A through 24D illustrate examples of estimating a behavior of an animal, based on activity data of the animal, according to an embodiment of the disclosure.

According to an embodiment, the activity data obtained through the wearable device 10 may be specifically learned according to a behavior pattern of the animal. In this case, an image obtained by capturing the animal may be used to match a specific behavior of the animal with a pattern of the activity data. For example, the specific behavior of the animal may be recognized from the image of the animal, and the specific behavior of the animal and the activity data of the animal matching the specific behavior may be acquired through time synchronization with the activity data obtained from the wearable device 10. Referring to FIG. 24A, the wearable device 10 may overlap x-axis, y-axis, and z-axis activity data collected through a plurality of sensors, and match a pattern indicated by each graph and the behavior of the animal through the NeuroSense algorithm. In the example of FIG. 24A, it may be estimated that the animal has performed behaviors, such as shaking 2401, walking 2402, running 2403, and shaking 2404 for a predetermined period of time.

Referring to FIG. 24B, activity data obtained for each dog may be collected differently depending on a behavior aspect of a specific dog, and thus activity data obtained from a dog A and activity data obtained from a dog B may show different patterns even with same shaking.

Referring to FIG. 24B, shaking 2411 of the dog A and shaking 2412 of the dog B may not be accurately distinguished by the eyes of a person, but the NeuroSense algorithm is able to distinguish the shaking 2411 and the shaking 2412 by learning behavior patterns of animals. Here, a NeuroSense algorithm may use types, ages, or the like of the animals as additive or subtractive factors while estimating a behavior of each animal.

Similarly, referring to FIGS. 24C and 24D, FIG. 24C illustrates activity data regarding scratching 2431 of the dog A and scratching 2432 of the dog B. As another example, FIG. 24D illustrates activity data regarding drinking and eating 2441 of the dog A, and drinking and eating 2442 of the dog B.

FIG. 25 illustrates an example of a frequency with respect to an estimated specific behavior of an animal, according to an embodiment of the disclosure. Referring to FIG. 25, a daily life pattern of the animal may be inferred from behaviors of the animal estimated for a predetermined period of time. For example, referring to FIG. 25, the animal has a high behavior frequency for running. Also, a behavior frequency for walking of the animal is also at an upper-middle level. Here, high or low, or a high/middle/low level of the behavior frequency may be presented as a relative value compared with an average behavior frequency of other animals.

When an animal has a very little activity amount, such as walking or running, or when an activity amount of the animal that was full of activity is rapidly decreased, the wearable device 10 may detect a health abnormality sign of the animal from an activity frequency of a specific behavior of the animal.

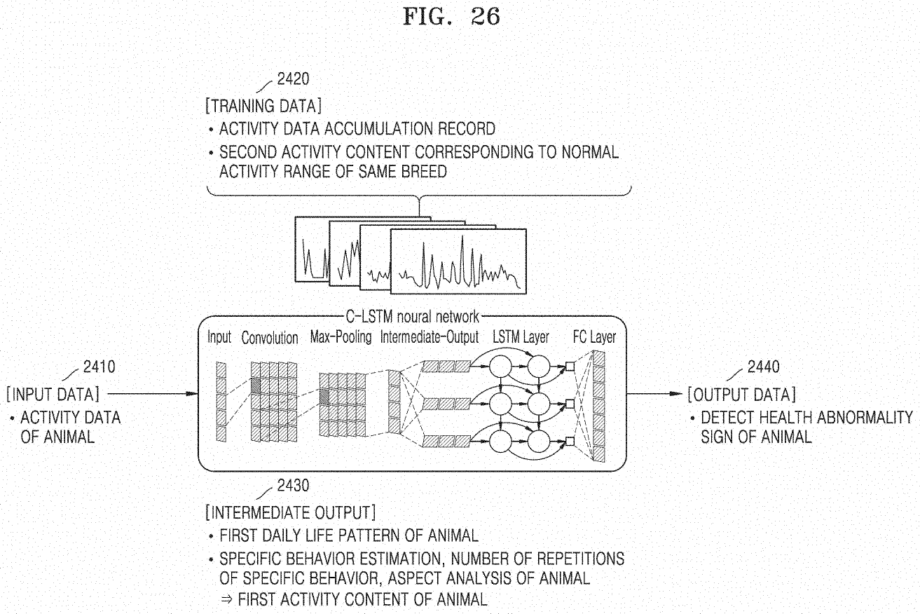

FIG. 26 is a diagram for describing an example of detecting a health abnormality sign of an animal by using a NeuroSense algorithm, according to an embodiment of the disclosure.

Referring to FIG. 26, pieces of data handled through the C-LSTM inference model among the NeuroSense algorithm may be largely described as below during a learning stage, an input stage, an intermediate output stage, and an output stage.

In the input stage, the wearable device 10 may input, as input data 2410, activity data of the animal to the C-LSTM inference model. Here, the wearable device 10 may perform predetermined preprocessing of performing an intermediate process using several inputs according to a predetermined time step, so as to input an input value to each layer of the C-LSTM inference model, by using the C-LSTM inference model.

In the learning stage, training data 2420 may include an activity data accumulation record and second activity content corresponding to a normal activity range of a same breed as the animal. Here, the activity data accumulation record may be a record in which activity data collected in predetermined units of time is accumulated. The activity data accumulation record of the animal may each be input to a hidden layer of the C-LSTM inference model, or may be used to infer a repeated daily life pattern of the animal.

For example, when activity data on the animal is collected over several days or months, the processor 14 may discover a pattern regarding behavior estimation of the animal through the C-LSTM inference model, and set the same as the normal activity range of the animal. Also, the processor 14 may monitor a change in the daily life pattern of the animal through activity data newly added after predetermined learning.

In addition, the processor 14 may learn an inference model using, as a parameter, a characteristic value for each behavior corresponding to the normal activity range of the same breed. For example, the processor 14 builds a breed-specific database for each animal belonging to the same breed, while collecting the activity data of the animal and behaviors of the animal corresponding to the activity data to build a training data set for training the C-LSTM inference model via supervised learning.

Here, when the training data set is built, the processor 14 may group main variables and dependent variables to calculate a correlation between variables, and the C-LSTM inference model may set the same as a parameter for detecting a health abnormality sign of the animal.

The C-LSTM inference model is a type of neural network model, and may be used to output an intermediate output 2430 and output data 2440 through following operations.

For example, the intermediate output 2430 may be first activity content of the animal, such as a first daily life pattern of the animal, specific behavior estimation of the animal, the number of repetitions of a specific behavior, and an aspect analysis.

For example, the C-LSTM inference model may extract features of N-gram through convolution. For example, one-dimensional convolution may include a filter vector that slides over a sequence and detects features at different locations. Accordingly, n feature maps generated for n filters having a same length may be rearranged into feature representations for each window.

Also, the C-LSTM inference model may perform maximum over-pooling or dynamic K max-pooling through max-pooling, and select a feature related to a specific behavior required to detect the health abnormality sign of the animal from among the features rearranged through the convolution.

The C-LSTM inference model may include at least 22 layers, and a cell state in each layer may be input, as an input, to a next layer. For example, the intermediate output 2430 may be input, as a vector, in a first layer and a subsequent layer of the C-LSTM inference model.

Each layer of the C-LSTM inference model may receive a previous calculation result as input to a next layer, and some layers may include a forget gate to prevent overfitting of an inference model. A fully connected (FC) layer may perform linear conversion according to a pre-set parameter, and output, as a final result, an abnormality sign detection result for an animal as a probability.

Here, the C-LSTM inference model may use various types of classifiers (like Support Vector Machine), and may include setting a variable to be first applied in each layer and an appropriate weight for each variable.

In the output stage, the C-LSTM inference model may detect the health abnormality sign of the animal as the output data 2440, through at least two LSTM layers and a final layer (the FC layer).

Here, when the activity data for the animal is input, the processor 14 may estimate the behavior of the animal from the activity data through the C-LSTM inference model, score specific behaviors related to the health abnormality sign from among the behaviors of the animal, and calculate a score for each behavior to analyze a behavior aspect of the behavior of the animal. Also, an analyzed activity history (second activity content) of the animal may be compared with the normal activity range by comparing the analyzed activity history with a predetermined threshold value.

For example, when several behaviors have been estimated from the activity data in a first stage through the C-LSTM inference model, the specific behaviors and behavior aspects related to the health abnormality sign may be classified, in a second stage, from among the behaviors estimated in the first stage, and thus the first activity content may be analyzed. Then, based on the first activity content analyzed in the second stage, the health abnormality sign of the animal may be detected.

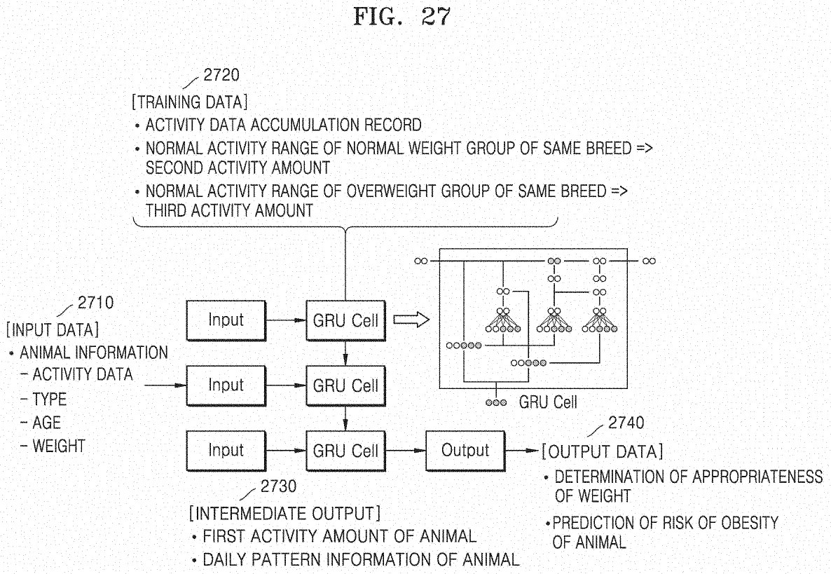

FIG. 27 is a diagram for describing an example of estimating a risk of obesity of an animal by using a NeuroSense algorithm, according to an embodiment of the disclosure. Here, determining of appropriateness of a weight of the animal and estimating of the risk of obesity of the animal through a GRU cell, which is an example of the NeuroSense algorithm, will be described.

Referring to FIG. 27, an input stage, a learning stage, and an output stage (including an intermediate output) into which each input data is input in parallel by using the GRU cell will be described as below.

In the input stage, the processor 14 may obtain a weight and activity data of a specific animal, and input the same to the NeuroSense algorithm, as input data 2710. The input data 2710 is animal information, and may include activity data, and a type, age, weight, and the like of the animal. The processor 14 may input the above information to the NeuroSense algorithm by combining at least one or a plurality of pieces of the information.

The processor 14 may analyze an activity amount of the animal from the activity data of the animal input through the NeuroSense algorithm. Here, the activity data may be used as a hidden state vector as a plurality of pieces of activity data collected in different time ranges according to predetermined units of time are each input to the GRU cell in parallel.

In the learning stage, training data 2720 may include an activity data accumulation record, a second activity amount corresponding to a normal activity range of a normal weight group of a same breed as the animal, and/or a third activity amount corresponding to a normal activity range of an overweight group of the same breed.

Here, activity data for animals of several breeds rather than the specific animal may be pre-collected. For example, a database may be built in which activity data collected for an animal of the same breed as the animal, and a corresponding second and/or third activity amount are used as a training data set.

In the GRU cell, each state of the input data 2710 may be input as a hidden state vector in a next stage. Referring to FIG. 25, the GRU cell may calculate a final output through a predetermined intermediate estimation stage.

Here, an intermediate output 2730 is a result estimated in an intermediate process for determining the appropriateness of the weight of the animal and estimating the risk of obesity of the animal, and may be obtained at any stage of the GRU cell. For example, the intermediate output 2730 may include a first activity amount of the animal estimated from the activity data, and a first daily life pattern of the animal.

In a final output stage, the processor 14 may output, as output data 2740, a result of determining the appropriateness of the weight of the animal and a result of estimating the risk of obesity of the animal. The result of estimating the risk of obesity may be presented as a probability value or an indicator corresponding to the probability value.

Here, the processor 14 may determine the appropriateness of the weight of the animal by comparing the first activity amount of the animal estimated from the activity data obtained by using the NeuroSense algorithm with the second activity amount corresponding to the normal activity range of the normal weight group or the third activity amount corresponding to the normal activity range of the overweight group, from among other animal groups of a same type, and estimate the risk of obesity of the animal.

FIG. 28 is a table for describing a battery management scenario of the wearable device 10, according to an embodiment of the disclosure. Referring to FIG. 26, the wearable device 10 may perform battery management by selecting an appropriate communication method according to circumstances.

For example, when an animal wearing the wearable device 10 is with an owner, the wearable device 10 may first select a Bluetooth connection as a communication method with the owner's terminal (that is, the terminal currently owned by the owner). When the wearable device 10 communicates with the owner's terminal only via Bluetooth, a life (hereinafter, referred to as a battery life) of the wearable device 10 when a battery of the wearable device 10 is fully charged may be about 4 months, but the battery life is not limited thereto.

Similarly, when the animal wearing the wearable device 10 is at home, Bluetooth and/or eMTC (LTE cellular) may be applied as a communication mode between the owner's terminal and the wearable device 10, in this case, communication between the owner's terminal and the wearable device 10 may be performed every 2 to 5 minutes. In this case, the battery life of the wearable device 10 may be about 3 months, but is not limited thereto.

When the animal wearing the wearable device 10 is outside, the wearable device 10 may use any one of Bluetooth and eMTC communication methods as a communication method with the owner's terminal. In this case, communication may be performed between the owner's terminal and the wearable device 10 every 2 to 5 minutes. In this case, the battery life of the wearable device 10 may be about one month, but is not limited thereto.

When the animal is missing, the wearable device 10 may be switched to a rescue mode through an application of the owner's terminal. In this case, the wearable device 10 may receive a GPS signal every minute for location tracking based on the GPS signal. Also, at this time, the wearable device 10 may also use the eMTC method for communication with the application. In this case, the battery life of the wearable device 10 may be about 2 days, but is not limited thereto.

The communication methods described in the above are according to a plurality of communication modes and battery usage scenarios that may be selected by the wearable device 10, and in some cases, communication methods, such as Wi-Fi, cellular, short-distance wireless communication, and the like may be used interchangeably.

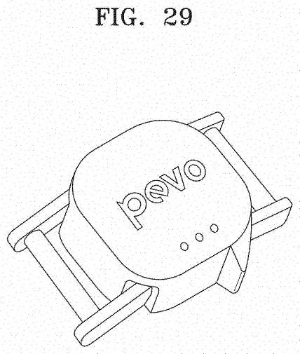

FIG. 29 illustrates an example of the wearable device 10, according to an embodiment of the disclosure. The wearable device 10 of the disclosure is a type of smart wearable device, and may track a daily life of an animal and provide an activity log of the animal to a user.

Here, data collected and analyzed by the wearable device 10 may be directly provided to the user through a communication method, such as Bluetooth, through an application interworking with the wearable device 10, or the data may be uploaded to a server managing the application through Wi-Fi, or the like to provide various types of information to the user.

Meanwhile, the disclosure may be implemented as a computer-readable recording medium having recorded thereon a program for executing the wearable device 10 for managing health of an animal on a computer.

Various embodiments of the disclosure are limited to a case where a wearable device is worn on a part of a body of an animal, but may be equally applied to a case where the wearable device is worn on a part of a body of a person. In detail, the wearable device is worn on the part of the body of the person to collect real-time state information of the person, and a user terminal may receive the real-time state information of the person, determine a health abnormality type of the person, and provide a solution according to the health abnormality type.

Various embodiments of the disclosure may be implemented as software (for example, a program) including one or more instructions stored in a machine-readable storage medium. For example, a processor of the machine may invoke and execute at least one of the one or more instructions stored from the storage medium. Accordingly, the machine is enabled to operate to perform at least one function according to the at least one invoked instruction. The one or more instructions may include code generated by a compiler or code executable by an interpreter. A machine-readable storage medium may be provided in a form of a non-transitory storage medium. Here, ‘non-transitory’ only means that the storage medium is a tangible device and does not contain a signal (for example, electromagnetic waves). This term does not distinguish a case where data is stored in the storage medium semi-permanently and a case where the data is stored in the storage medium temporarily.

According to an embodiment, a method according to various embodiments of the disclosure may be provided by being included in a computer program product. The computer program product is a product that can be traded between sellers and buyers. The computer program product may be distributed in a form of machine-readable storage medium (for example, a compact disc read-only memory (CD-ROM)), or distributed through an application store (for example, Play Store™) or directly or online between two user devices (for example, download or upload). In the case of online distribution, at least a part of the computer program product may be temporarily stored or temporarily generated in the machine-readable storage medium such as a server of a manufacturer, a server of an application store, or a memory of a relay server.

Furthermore, in the specification, the term “unit” may be a hardware component such as a processor or circuit and/or a software component that is executed by a hardware component such as a processor.

The scope of the disclosure is defined by the appended claims rather than the detailed description, and all changes or modifications within the scope of the appended claims and their equivalents will be construed as being included in the scope of the disclosure.

According to embodiments of the disclosure, health of an animal may be more efficiently managed by receiving real-time state information of the animal from a wearable device, and providing a health abnormality type and solution of the animal, based on the real-time state information.

According to embodiments of the disclosure, a solution most suitable to a current health condition of an animal may be provided by updating the solution based on a performance achievement of a task provided as the solution and new real-time state information received after the task is performed.

According to embodiments of the disclosure, a health abnormality type of an animal may be more accurately determined by considering not only real-time state information of an animal, but also basic information of the animal.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A non-transitory computer-readable storage medium storing instructions configured to cause a processor for calculating a recommended feed amount based on animal characteristic information to:
receive one or more pieces of first animal characteristic information, wherein the one or more pieces of first animal characteristic information include at least piece of activity level information of a first animal; and
calculate a maintenance energy requirement (MER) of the first animal, based on the received one or more pieces of first animal characteristic information and an MER calculation model.

2. The storage medium of claim 1, wherein the at least one piece of activity level information of the first animal is generated based on a measurement activity value measured by a wearable device attached to the first animal or a processed activity value generated based on the measurement activity value.

3. The storage medium of claim 2, wherein the measurement activity value comprises an acceleration value measured by the attached wearable device according to activity of the first animal.

4. The storage medium of claim 3, wherein the processed activity value comprises at least one of an activity energy value or an activity intensity value generated based on the acceleration value.

5. The storage medium of claim 2, wherein the at least one piece of activity level information is generated by using an activity level determination model for determining the at least one piece of activity level information according to the measurement activity value or the processed activity value, and
the activity level determination model generates the at least one piece of activity level information by using a level of the measurement activity value or the processed activity value compared to a recommended activity amount of the first animal.

6. The storage medium of claim 1, wherein the instructions further cause the processor to convert the one or more pieces of first animal characteristic information into a first characteristic value according to a preset conversion criterion,
wherein the preset conversion criterion is constructed based on a plurality of pieces of animal characteristic information, in which at least one of pieces of animal characteristic sub-information is the same as the first animal.

7. The storage medium of claim 6, wherein the animal characteristic sub-information comprises at least one of species information of an animal or animal age information.

8. The storage medium of claim 1, wherein the instructions further cause the processor to generate state information of the first animal based on the one or more pieces of first animal characteristic information, wherein the one or more pieces of first animal characteristic information further includes species information of the first animal.

9. The storage medium of claim 8, wherein the state information of the first animal is generated by selecting one of one or more pieces of candidate state information, based on the species information of the first animal.

10. The storage medium of claim 1, wherein the instructions further cause the processor to:
calculate a recommended feed amount for the first animal based on the MER of the first animal; and
provide, to a user, a notification of whether to repurchase feed, based on the recommended feed amount.

11. The storage medium of claim 10, wherein the instructions further cause the processor to provide, to the user, recommended feed information based on the one or more pieces of first animal characteristic information.

12. A method of calculating a recommended feed amount, based on animal characteristic information, the method comprising:
receiving, at a processor, one or more pieces of first animal characteristic information, wherein the one or more pieces of first animal characteristic information are related to one or more pieces of information measured by a wearable device attached to a first animal; and
calculating, at the processor, a maintenance energy requirement (MER) of the first animal, based on the received one or more pieces of first animal characteristic information and an MER calculation model.
